(19) United States
(12) Patent Application Publication
(10) Pub. No.: US 2007/0201692 A1
(43) Pub. Date: Aug. 30, 2007

(54) Data transmission apparatus, data transmission method

(76) Inventors: Satoshi Furusawa, Osaka (JP); Masaru Fuse, Osaka (JP); Tsuyoshi Ikushima, Nara (JP); Tomokazu Sada, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/699,019

(22) Filed: Jan. 29, 2007

(30) Foreign Application Priority Data
Feb. 7, 2006 (JP) 2006-029771

(51) Int. Cl. H04L 9/00

(52) U.S. Cl. 380/45

(57) ABSTRACT

A data communication apparatus which causes the eavesdropper to take a significantly increased time to analyze a cipher text and provides high concealability is provided. In a modulator section 112a, a branching section 114 branches a lightwave 20 outputted from a light source 113, and outputs respective branched lights to a first light path 117 and a second light path 118 respectively having different light path lengths. A light modulator section 116 modulates, based on a multi-level signal 13, a lightwave propagating at least one light path of the first light path 117 and the second light path 118. An interference section 119 causes the lightwaves outputted from the first light path 117 and the second light path 118 to interfere with each other, and outputs such interfered lightwave as a modulated signal 14.

### BACKGROUND OF THE INVENTION

1. Field of the Invention

The preset invention relates to an apparatus and a method for performing secret communication in order to avoid illegal eavesdropping and interception by a third party, more particularly, relates to a data transmitting apparatus and a data transmitting method for performing data communication through selecting and setting a specific encoding/decoding (modulating/demodulating) method between a legitimate transmitter and a legitimate receiver.

2. Description of the Background Art

Conventionally, in order to perform secret communication between specific parties, there has been adopted a structure for realizing secret communication by sharing key information for encoding/decoding between transmitting and receiving ends and by performing, based on the key information, an operation/inverse operation on information data (plain text) to be transmitted, in a mathematical manner. FIG. 17 is a block diagram showing a structure of a conventional data communication apparatus based on the above-described structure.

In FIG. 17, the conventional data communication apparatus has a configuration in which a data transmitting apparatus 9001 and a data receiving apparatus 9002 are connected to each other via a transmission line 913. The data transmitting apparatus 9001 includes an encoding section 911 and a modulator section 912. The data receiving apparatus 9002 includes a demodulator section 914 and a decoding section 915.

In the data transmitting apparatus 9001, information data 90 and first key information 91 are inputted to the encoding section 911. The encoding section 911 encodes (modulates), based on the first key information 91, the information data 90. The modulator section 912 converts, in a predetermined demodulation method, the information data 90 encoded by the encoding section 911 into a modulated signal 94 which is then transmitted to the transmission line 913.

In the data receiving apparatus 9002, the demodulator section 914 demodulates, in a predetermined demodulation method, the modulated signal 94 transmitted via the transmission line 913. To the decoding section 915, second key information 96 which has the same content as the first key information 91 is inputted. The decoding section 915 demodulates (decrypts), based on the second key information 96, the modulated signal 94 and then outputs information data 98.

Here, eavesdropping by a third party will be described by using an eavesdropper receiving apparatus 9003. In FIG. 17, eavesdropper receiving apparatus 9003 includes an eavesdropper demodulator section 916 and an eavesdropper decoding section 917. The eavesdropper demodulator section 916 demodulates, in a predetermined demodulation method, the modulated signal 94 transmitted via the transmission line 913. The eavesdropper decoding section 917 attempts, based on third key information 99, decoding of a signal demodulated by the eavesdropper demodulator section 916. Here, since the eavesdropper decoding section 917 attempts, based on the third key information 99 which is different in content from the first key information 91, decoding of the signal demodulated by the eavesdropper demodulator section 916, the information data 98 cannot be reproduced accurately.

A mathematical encryption (or also referred to as a computational encryption or a software encryption) technique based on such mathematical operation may be applicable to an access system described in Japanese Laid-Open Patent Publication No. 9-205420 (hereinafter referred to as Patent Document 1), for example. That is, in a PON (Passive Optical Network) system in which an optical signal transmitted from an optical transmitter is divided by an optical coupler and distributed to optical receivers at a plurality of optical subscribers' houses, such optical signals that are not desired and aimed at another subscribers are inputted to each of the optical receivers. Therefore, the PON system encrypts information data for each of the subscribers by using key information which is different by the subscribers, thereby preventing a leakage/eavesdropping of mutual information data and realizing safe data communication.

Further, the mathematical encryption technique is disclosed in, for example, William Stallings, “Cryptography and Network Security Principles and Practice, Second Edition”, Prentice Hall, 1998 translated by Keiichiro Ishibashi et al, Pearson Education, 2001 (hereinafter referred to as Non-patent Document 1), and Bruce Schneier, “Applied Cryptography, Second Edition”, John Wiley & Sons Inc, 1996 translated by Mayumi Adachi et al, Softbank publishing, 2003 (hereinafter referred to as Non-patent Document 2).

However, in the case of the conventional data communication apparatus based on the mathematical encryption technique, it is theoretically possible for the eavesdropper to decrypt, even if the eavesdropper does not share the key information, a cipher text (a modulated signal or encrypted information data) by performing operations (all possible attacks) using all possible combinations of key information, or by means of a special analysis algorithm. Particularly, improvement in processing speed of a computer has been remarkable in recent years, and thus there has been a problem in that if a new computer based on a novel principle such as a quantum computer is realized in the future, it is possible to eavesdrop on the cipher text easily within finite lengths of time.

### SUMMARY OF THE INVENTION

Therefore, an object of the present invention is to provide a data communication apparatus which causes the eavesdropper to take a significantly increased time to analyze the cipher text and provides high concealability.

The present invention is directed to a data transmitting apparatus for encrypting information data by using predetermined key information and performing secret communication with a receiving apparatus. To attain the above-described objects, the data transmitting apparatus of the present invention includes: a multi-level code generation section for generating, based on the predetermined key information, a multi-level code sequence in which a signal level changes so as to be approximately random numbers; a multi-level processing section for combining the multi-level code sequence and the information data and generating a multi-level signal having a plurality of levels corresponding to a combination of the multi-level code sequence and the information data; and a modulator section for modulating the multi-level signal based on predetermined modulation processing and outputting the same as a modulated signal. The modulator section includes: a branching section for branching a lightwave outputted from a light source, and outputting respective branched lights to a first light path and a second light path respectively having different light path lengths; a light modulator section for modulating, based on the multi-level signal, a lightwave propagating through at least one light path of the first light path and the second light path; and an interference section for causing lightwaves, which are outputted from the first light path and the second light path, to interfere with each other, and outputting an interfered lightwave as the modulated signal.

Further, the data transmitting apparatus of the present invention may be of a configuration including a modulator section as described follows. The modulator section includes: a branching section for branching a lightwave outputted from a light source, and outputting respective branched lights to a first light path and a second light path respectively having different light path lengths; an interference section for causing lightwaves, which are outputted from the first light path and the second light path, to interfere with each other, and outputting an interfered lightwave as a combined wave; and a light modulator section for modulating, based on the multi-level signal, the combined wave outputted from the interference section.

Further, the data transmitting apparatus of the present invention may be of a configuration including a modulator section as described as follows. The modulator section includes: a light modulator section for modulating, based on the multi-level signal, a lightwave outputted from a light source; a branching section for branching an output from the light modular section, and outputting respective branched lights to a first light path and a second light path respectively having different light path lengths; and an interference section for causing lightwaves, which are outputted from the first light path and the second light path, to interfere with each other, and outputting an interfered lightwave as the modulated signal.

Further, the data transmitting apparatus of the present invention may be of a configuration including a modulator section as described as follows. The modulator section includes: a light transmitting section which is allocated on a propagation path of a lightwave outputted from a light source; and a light modulator section for modulating, based on the multi-level signal, a lightwave outputted from the light transmitting section. The light transmitting section includes: a first transmitting/reflecting section for causing the lightwave outputted from the light source to transmit at a predetermined transmission factor and to reflect at a predetermined reflection factor, respectively; a second transmitting/reflecting section for causing a lightwave outputted from the first transmitting/reflecting section to transmit at a predetermined transmission factor and to reflect at a predetermined reflection factor, respectively; and a light path which has a predetermined light path length and is allocated between the first transmitting/reflecting section and the second transmitting/reflecting section.

It is preferable that a difference in the light path lengths between the first light path and the second light path is equal to or longer than a coherent length of a lightwave to be inputted to the modulator section. Alternatively, the difference in the light path lengths between the first light path and the second light path may be generated in a delaying section which is allocated on at least one of the first light path and the second light path.

It is preferable that the interference section includes: an amplitude adjustment section for attenuating an amplitude of the lightwave propagating through at least one light-path of the first light path and the second light path; and a combining section for combining the lightwaves outputted from the first light path and the second light path.

It is preferable that the interference section includes: a polarization adjustment section for adjusting polarization of the lightwave propagating through at least one light path of the first light path and the second light path; and a combining section for combining the lightwaves outputted from the first light path and the second light path.

It is preferable that the amplitude adjustment section varies, based on a control signal inputted externally, an attenuation level of a lightwave to be inputted. The polarization adjustment section varies, based on a control signal inputted externally, the polarization of an lightwave to be inputted. A light path length of the light path having the predetermined light path length is equal to or more than 0.5 times of a coherent length of the lightwave outputted from the light source.

It is preferable that the modulator section further includes an interference control section for performing a feedback control of a ratio of the combined wave in the interference section in accordance with a level of an interference noise included in a lightwave outputted from at least either of the interference section or the light modulator section.

The interference control section includes: a detection section for performing a photoelectric conversion of a lightwave to be inputted and detecting the interference noise; and a control section for outputting, based on a result of detection by the detection section, a control signal to the interference section.

Further, the present invention is also directed to a data transmitting method for encrypting information data by using predetermined key information and performing secret communication with a receiving apparatus. To attain the above-described object, the data transmitting method of the present invention includes: a multi-level code generation step of generating, based on the predetermined key information, a multi-level code sequence in which a signal level changes so as to be approximately random numbers; a multi-level processing step of combining the multi-level code sequence and the information data and generating a multi-level signal having a plurality of levels corresponding to a combination of the multi-level code sequence and the information data; and a modulation step of modulating the multi-level signal based on predetermined modulation processing and outputting a modulated signal. The modulation step includes: a branching step of branching a lightwave outputted from a light source, and outputting respective branched lights to a first light path and a second light path respectively having different light path lengths; a light modulation step of modulating, based on the multi-level signal, a lightwave propagating through at least one light path of the first light path and the second light path; and an interfering step of causing the lightwaves, which are outputted from the first light path and the second light path, to interfere with each other, and outputting an interfered lightwaves as the modulated signal.

Further, the data transmitting method of the present invention may include a modulation step as described as follows. The modulation step includes: a branching step of branching a lightwave outputted from a light source, and outputting respective branched lights to a first light path and a second light path respectively having different light path lengths; an interfering step of causing lightwaves, which are outputted from first light path and the second light path, to interfere with each other, and outputting an interfered lightwaves as a combined wave; and a light modulation step of modulating, based on the multi-level signal, the combined wave.

Further, the data transmitting method of the present invention may include a modulation step as described as follows. The modulation step includes: a light modulation step of modulating, based on the multi-level signal, a lightwave outputted from a light source; a branching step of branching the lightwave modulated based on the multi-level signal and outputting respective branched lights to a first light path and a second light path respectively having different light path lengths; and an interfering step of causing lightwaves, which are outputted from the first light path and the second light path, to interfere with each other, and outputting an interfered lightwave as the modulated signal.

Further, the data transmitting method of the present invention may include a modulation step as described as follows. The modulation step includes: a light transmitting step of transmitting a lightwave outputted from a light source; and a light modulation step of modulating, based on the multi-level signal, the lightwave outputted from the light transmitting step. The light transmitting step includes: a first transmitting/reflecting step of causing the lightwave outputted from the light source to transmit at a predetermined transmission factor and to reflect at a predetermined reflection factor, respectively; and a second transmitting/reflecting step of causing the lightwave, which is outputted from the first transmitting/reflecting step and then outputted after passing through a light path having a predetermined light path length, to transmit at a predetermined transmission factor and to reflect at a predetermined reflection factor.

The data transmitting apparatus of the present invention encodes/modulates information data by using key information into a multi-level signal, and demodulates/decodes a received multi-level signal by using the key information, thereby optimizing a signal-to-noise power ratio. Accordingly, it is possible to significantly increase time to analyze the cipher text and provides high concealable data communication. Further a modulated signal, which is a combined signal of two lightwaves passed through a long path and a short path, is sent out, whereby it is possible to generate a noise which is difficult to avoid before/after detection and excels in controllability, significantly deteriorate quality of a receiving signal at the time of eavesdropping by a third party, and provide a safe data communication apparatus which causes decryption/decoding of the multi-level signal to be difficult.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing an example of a configuration of a data communication apparatus according to the present invention;

FIG. 2 is a flowchart illustrating an example of an action of the data communication apparatus according to the first embodiment of the present invention;

FIG. 3 is a diagram illustrating waveforms of a transmission signal of the data communication apparatus according to the first embodiment of the present invention;

FIG. 4A is a diagram illustrating names of the waveforms of the transmission signal of the data communication apparatus according to the first embodiment of the present invention.

FIG. 4B is a diagram illustrating quality of the transmission signal of the data communication apparatus according to the first embodiment of the present invention;

FIG. 5 is a diagram illustrating the quality of another transmission signal of the data communication apparatus according to the first embodiment of the present invention;

FIG. 6 is a block diagram showing an example of a configuration of a data communication apparatus according to a second embodiment of the present invention;

FIG. 7A is a diagram illustrating a waveform of an optical multi-level signal of the data transmitting apparatus 1102 according to the second embodiment of the present invention;

FIG. 7B is a flowchart illustrating an example of an action of a modulator section 112a according to the second embodiment of the present invention;

FIG. 8 is a diagram illustrating overlapped noises caused by the data transmitting apparatus 1102 according to the second embodiment of the present invention;

FIG. 9 is a diagram illustrating locations of wavelengths of an optical multi-level signal of the data transmitting apparatus 1102 according to the second embodiment of the present invention;

FIG. 10 is a block diagram showing an example of a configuration of a data transmitting apparatus 1103 according to a third embodiment of the present invention;

FIG. 11A is a diagram illustrating allocations of wavelengths of an optical multi-level signal of the data transmitting apparatus 1103 according to the third embodiment of the present invention;

FIG. 11B is a flowchart illustrating an example of an action of a modulator section 112b according to the third embodiment of the present invention;

FIG. 12 is a block diagram showing an example of a configuration of a data transmitting apparatus 1104 according to a fourth embodiment of the present invention;

FIG. 13A is a diagram illustrating allocations of wavelengths of an optical multi-level signal of the data transmitting apparatus 1104 according to the fourth embodiment of the present invention;

FIG. 13B is a flowchart illustrating an example of an action of a modulator section 112c according to the fourth embodiment of the present invention;

FIG. 14 is a block diagram showing an example of a configuration of a data transmitting apparatus 1105 according to a fifth embodiment of the present invention;

FIG. 15A is a diagram illustrating a flow of a lightwave in a light transmitting section 124;

FIG. 15B is a flowchart illustrating an example of an action of a modulator section 112d according to the fifth embodiment of the present invention;

FIG. 16 is a block diagram showing an example of a configuration of a data transmitting apparatus 1106 according to a sixth embodiment of the present invention; and

FIG. 17 is a block diagram showing a configuration of a conventional data communication apparatus.

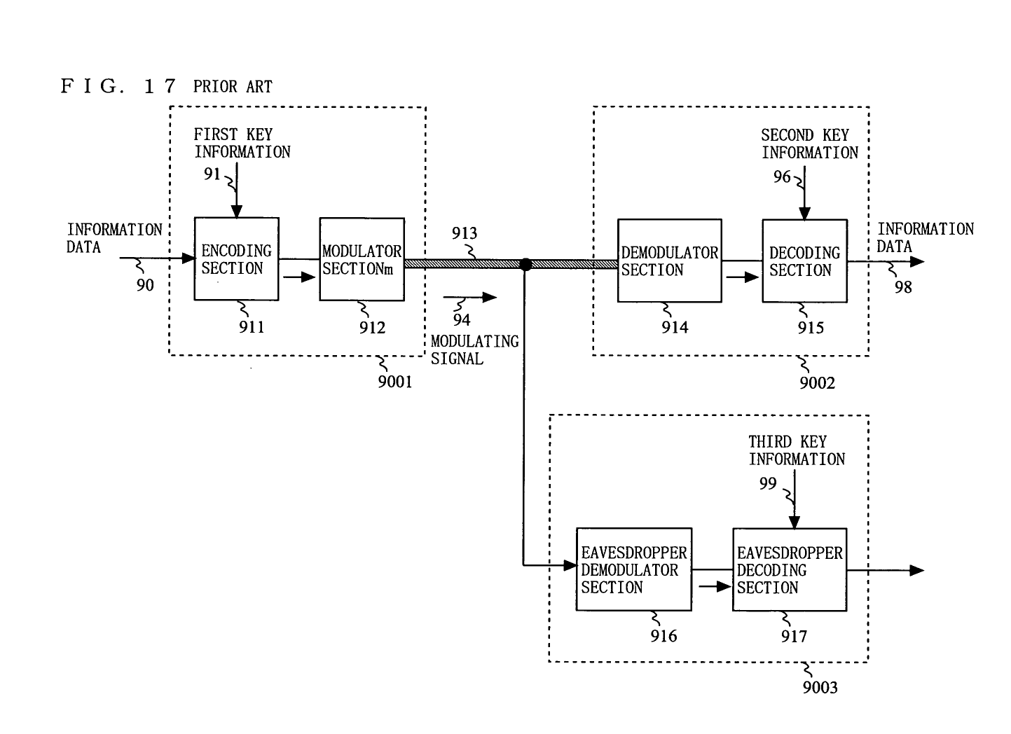

### DESCRIPTION OF THE PREFERRED EMBODIMENTS

Hereinafter, embodiment of the present invention will be described, with reference to drawings.

### First Embodiment

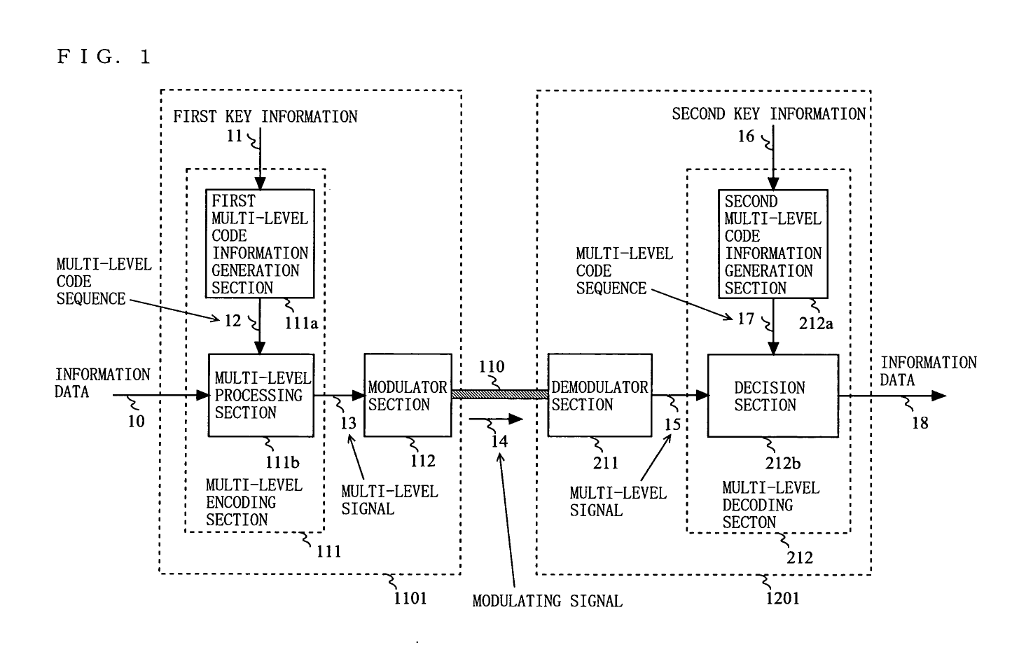

FIG. 1 is a block diagram showing an example of a configuration of a data communication apparatus according to the present invention. In FIG. 1, the data communication apparatus according to the first embodiment has a configuration in which a data transmitting apparatus 1101 and a data receiving apparatus 1201 are connected to each other via a transmission line 110. The data transmitting apparatus 1101 includes a multi-level encoding section 111 and a modulator section 112. The multi-level encoding section 111 includes a first multi-level code generation section 111a and a multi-level processing section 111b. The data receiving apparatus 1201 includes a demodulator section 211 and a multi-level decoding section 212. The multi-level decoding section 212 includes a second multi-level code generation section 212a and a decision section 212b. A metal line such as a LAN cable or a coaxial line, or an optical waveguide such as an optical-fiber cable can be used as the transmission line 110. Further the transmission line 110 is not limited to a wired cable such as the LAN cable, but can be free space which enables a wireless signal to be transmitted.

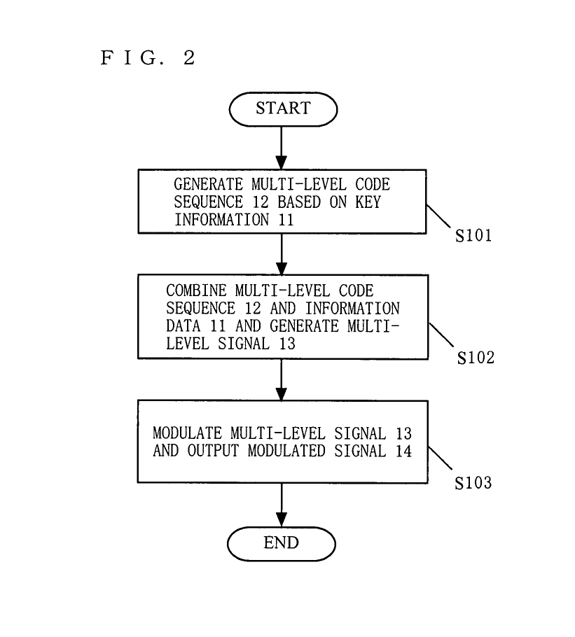

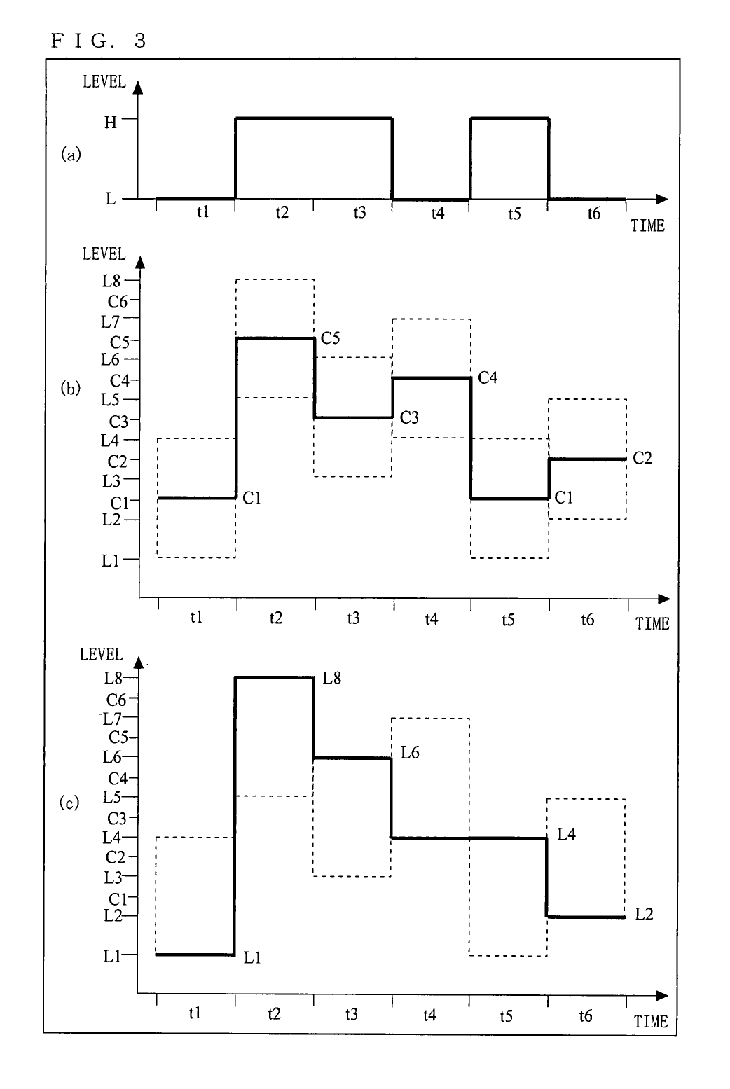

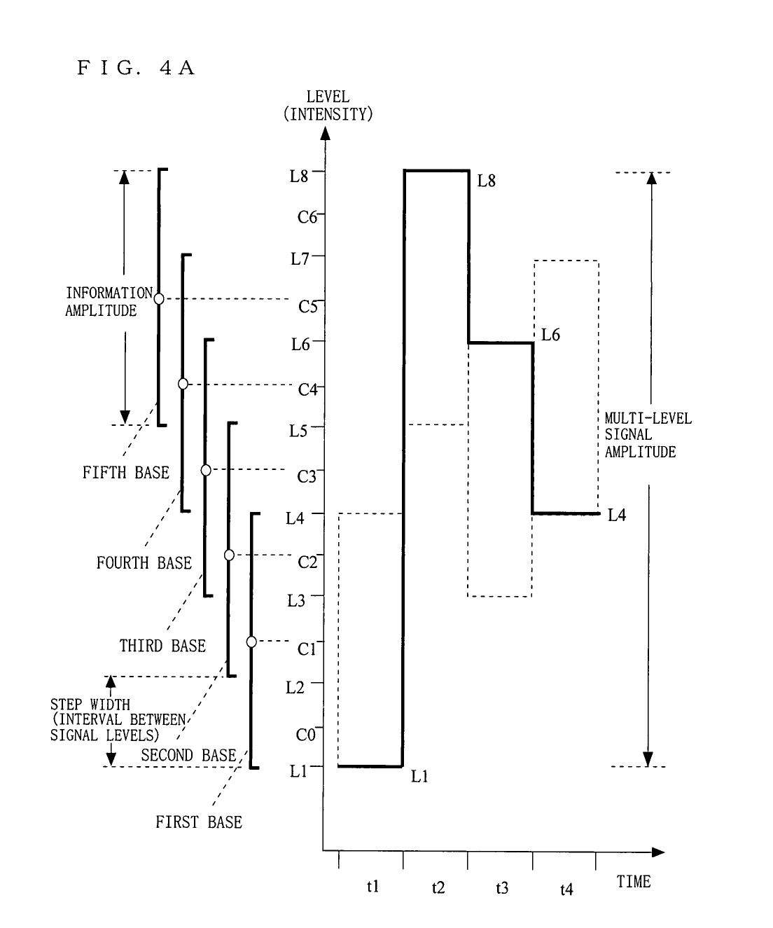

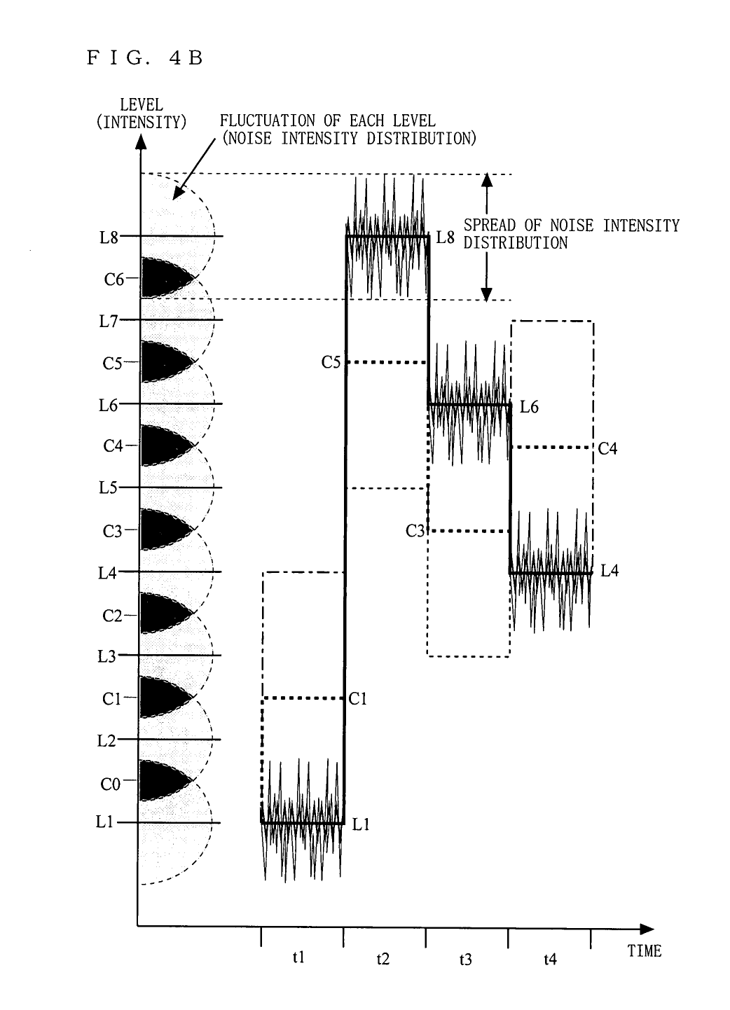

FIG. 2 is a flowchart illustrating an example of an action of the data communication apparatus according to the first embodiment of the present invention. FIG. 3 is a diagram illustrating waveforms of a transmission signal of the data communication apparatus according to the first embodiment of the present invention. FIG. 4A is a diagram illustrating names of the waveforms of the transmission signal of the data communication apparatus according to the first embodiment of the present invention. FIG. 4B is a diagram illustrating quality of the transmission signal of the data communication apparatus according to the first embodiment of the present invention. Hereinafter, an action of the data communication apparatus according to the first embodiment of the present invention will be described, with reference to drawings.

With reference to FIG. 2, the first multi-level code generation section 111a generates, based on predetermined first key information 11, a multi-level code sequence in which a signal level changes so as to be approximately random numbers (step S101). The multi-level code sequence 12 and information data 10 are inputted to the multi-level processing section 111b. The multi-level processing section 111b combines the multi-level code sequence 12 and the information data 10 in accordance with a predetermined procedure, and generates a multi-level signal 13 having a plurality of levels corresponding to a combination of the multi-level code sequence 12 and the information data 10 (step S102). For example, in the case where a level of the multi-level code sequence 12 changes to c1/c5/c3/c4 with respect to time slots t1/t2/t3/t4 (see FIG. 3(b)), the multi-level processing section 111b regards the multi-level code sequence 12 as a bias level, adds thereto the information data 10, and then generates the multi-level signal 13 in which a signal level changes to L1/L8/L6/L4 (see FIG. 3(c)). The modulator section 112 modulates the multi-level signal 13 in a predetermined modulation method, and outputs the modulated multi-level signal 13 as a modulated signal 14 to the transmission line 110 (step S103).

Here, as shown in FIG. 4A, an amplitude of the information data 10 is referred to as an “information amplitude”, a total amplitude of the multi-level signal 13 is referred to as a “multi-level signal amplitude”, pairs of levels (L1, L4)/(L2, L5)/(L3, L6)/(L4, L7)/(L5, L8) which the multi-level signal 13 may take corresponding to the levels of the multi-level code sequence 12 c1/c2/c3/c4/c5 are respectively referred to as a first to a fifth “bases”, and a minimum interval between signal levels of the multi-level signal 13 is referred to as a “step width”.

The demodulator section 211 demodulates the modulated signal 14 transmitted via the transmission line 110, and reproduces a multi-level signal 15. The second multi-level code generation section 212a previously shares second key information 16 which has the same content as the first key information 11, and based on the second key information 16, generates a multi-level code sequence 17. The decision section 212b receives the multi-level signal 15, and decides (binary determination) the logic of the information data by using the multi-level code sequence 17 as a threshold, and reproduces information data 18. Here, the modulated signal 14 which is modulated in a predetermined modulation method and is transmitted/received between the modulator section 112 and the demodulator section 211 via the transmission line 110, is a signal obtained by modulating an electromagnetic wave (electromagnetic field) or a lightwave using the multi-level signal 13.

Note that the multi-level processing section 111b may generate the multi-level signal 13 by using any methods, in addition to a method of generating the multi-level signal 13 by adding the information data 10 and the multi-level code sequence 12 as above described. For example, the multi-level processing section 111b may generate the multi-level signal 13 by modulating, based on the information data 10, an amplitude of the levels of the multi-level code sequence 12. Alternatively, the multi-level processing section 111b may generate the multi-level signal 13 by reading out consecutively, from a memory having levels of the multi-level signal 13 stored therein, the levels of the multi-level signal 13, which are corresponding to the combination of the information data 10 and the multi-level code sequence 12.

Further, in FIG. 3 and FIG. 4, the levels of the multi-level signal 13 are represented as 8 levels, but the levels of the multi-level signal 13 are not limited to the representation. Further, the information amplitude is represented as three times or integer times of the step width of the multi-level signal 13, but the information amplitude is not limited to the representation. Further, in FIG. 3 and FIG. 4A, each of the levels of the multi-level code sequence 12 is located so as to be at an approximate center between each of the levels of the multi-level signal 13, but each of the levels of the multi-level code sequence 12 is not limited to such location. For example, each of the levels of the multi-level code sequence 12 is not necessarily at the approximate center between each of the levels of the multi-level signal 13, or may coincide with each of the levels of the multi-level signal 13. Further, the above description is based on an assumption that the multi-level code sequence 12 and the information data 10 are identical in a change rate to each other and also in a synchronous relation, but the change rate of either of the multi-level code sequence 12 or the information data 10 may be faster (or slower) than the change rate of another, or the multi-level code sequence 12 and the information data 10 are in an asynchronous relation.

Next, an action of eavesdropping by a third party will be described. It is assumed that the third party, who is an eavesdropper, decodes the modulated signal 14 by using a configuration corresponding to the data receiving apparatus 1201 held by a legitimate receiving party or a further sophisticated data receiving apparatus (hereinafter referred to as an eavesdropper data receiving apparatus). The eavesdropper data receiving apparatus reproduces the multi-level signal 15 by demodulating the modulated signal 14. However, the eavesdropper data receiving apparatus does not share the key information with the data transmitting apparatus 1101, and thus, unlike the data receiving apparatus 1201, the eavesdropper data receiving apparatus cannot generate, based on the key information, the multi-level code sequence 17. Therefore, the eavesdropper data receiving apparatus cannot perform binary determination of the multi-level signal 15 by using the multi-level code sequence 17 as a reference.

As an action of the eavesdropping which may be possible under these circumstances, there is a method of identifying all the levels of the multi-level signal 15 (generally referred to as “all-possible attacks). That is, the eavesdropper data receiving apparatus performs determination of the multi-level signal 15 by preparing thresholds corresponding to all possible intervals between the signal levels which the multi-level signal 15 may take, and attempts extraction of correct key information or information data by analyzing a result of the determination. For example, the eavesdropper data receiving apparatus sets all the levels c0/c1/c2/c3/c4/c5/c6 of the multi-level code sequence 12 shown in FIG. 3 as the thresholds, and performs the multi-level determination of the multi-level signal 15, thereby attempting the extraction of the correct key information or the information data.

However, in an actual transmission system, a noise occurs due to various factors, and the noise is overlapped on the modulated signal 14, whereby the levels of the multi-level signal 15 fluctuates temporally/instantaneously as shown in FIG. 4B. In this case, a SN ratio of a signal (the multi-level signal 15) to be determined by the legitimate receiving party (the data receiving apparatus 1201) is determined based on a ratio of the information amplitude to a noise level of the multi-level signal 15. On the other hand, the SN ratio of the signal (the multi-level signal 15) to be determined by the eavesdropper data receiving apparatus is determined based on a ratio of the step width to the noise level of the multi-level signal 15.

Therefore, in the case where a condition of the noise level contained in the signal to be determined is fixed, the SN ratio of the signal to be determined by the eavesdropper data receiving apparatus is relatively smaller than that by the data receiving apparatus 1201, and thus a transmitting feature (an error rate) of the eavesdropper data receiving apparatus deteriorates. The data communication apparatus of the present invention utilize this feature so as to induce an identification error in the all-possible attacks by the third party using all the thresholds, thereby causing the eavesdropping to be difficult. Particularly, in the case where the step width of the multi-level signal 15 is set an order equal to or smaller than a noise amplitude (spread of a noise intensity distribution), the data communication apparatus substantially disables the multi-level determination by the third party, thereby realizing an ideal eavesdropping prevention.

As the noise to be overlapped on the signal to be determined (the multi-level signal 15 or the modulated signal 14), a thermal noise (Gaussian noise) included in a space field or an electronic device, etc. may be used, in the case where an electromagnetic wave such as a wireless signal is used as the modulated signal 14, and a photon number distribution (quantum noise) may be used in addition to the thermal noise, in the case where the lightwave is used. Particularly, signal processing such as recording and replication is not applicable to a signal including the quantum noise, and thus the step width of the multi-level signal 15 is set by using the quantum noise level as a reference, whereby the eavesdropping by the third party is disabled and an absolute safety of the data communication is secured.

As above described, according to the data communication apparatus based on the first embodiment of the present invention, when the information data to be transmitted is encoded as the multi-level signal, the interval between the signal levels of the multi-level signal 13 is set in reference to the noise level so as to disable eavesdropping by the third party. Accordingly, quality of the receiving signal at the time of the eavesdropping by the third party is crucially deteriorated, and it is possible to provide a further safe data communication apparatus which causes decryption/decoding of the multi-level signal by the third party to be difficult.

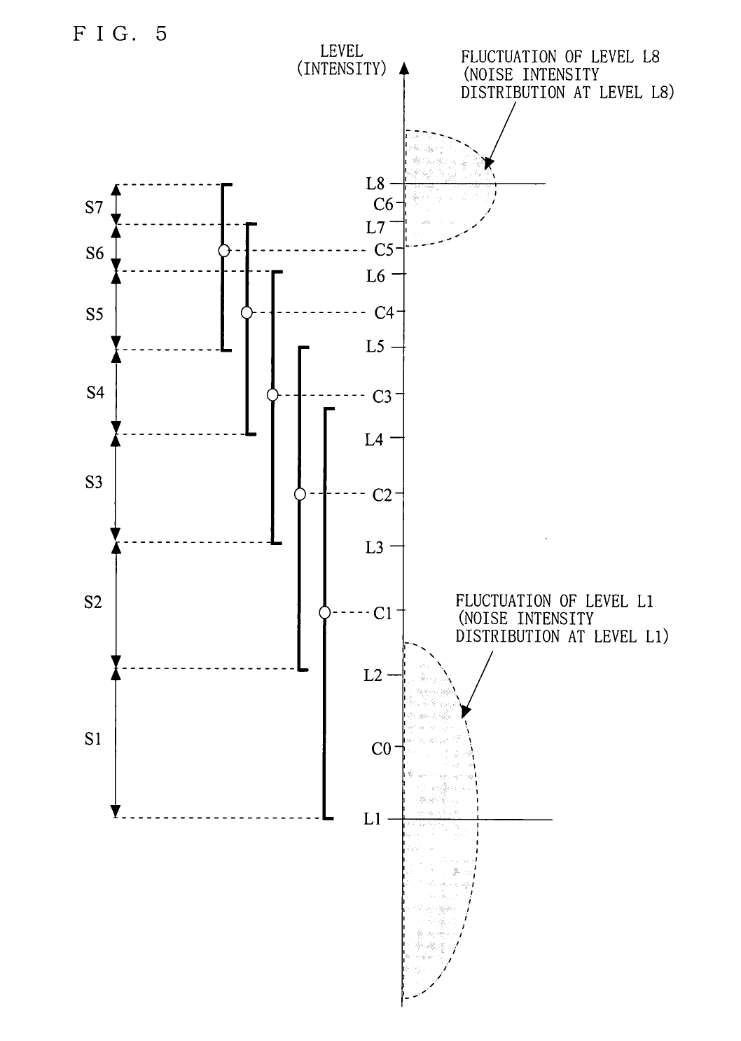

Note that the multi-level encoding section 111 may fluctuate the step width (S1 to S7) of the multi-level signal 13, as shown in FIG. 5, depending on a fluctuation level of each of the levels of the multi-level signal 13, that is, the noise intensity distribution overlapped on each of the levels. Specifically, the multi-level encoding section 111 distributes the interval between the signal levels of the multi-level signal 13 such that respective SN ratios which are determined by respective adjoining two signal levels of the signal to be determined and to be inputted to the decision section 212b become approximately uniform. Further, the multi-level encoding section 111 sets the step width of each of the levels of the multi-level signal 13 in a uniform manner, in the case where the noise level to be overlapped on each of the levels is constant.

Generally, in the case where a light intensity modulated signal whose light source is a diode laser (LD) is assumed as the modulated signal 14 outputted from the modulator section 112, a fluctuation width (the noise level) of the modulated signal 14 will vary depending on the levels of the multi-level signal 13 inputted to the diode laser. This results from the fact that the diode laser emits light based on the principle of stimulated emission which uses a spontaneous emission light as a “master light”, and the noise level contained in the modulated signal outputted from the diode laser is defined based on a relative ratio of a stimulated emission light level to a spontaneous emission light level. That is, the higher an excitation rate of the diode laser (a bias current to be injected into the LD) is, the larger a ratio of the stimulated emission light level becomes, and consequently the noise level becomes small. On the other hand, the lower the excitation rate of the diode laser is, the larger a ratio of the natural emission light level becomes, and consequently the noise level becomes large. Accordingly, as shown in FIG. 5, the multi-level encoding section 111 sets the step width large in a range where the level of the multi-level signal 13 is small, and sets the step width small in a range where the level of the multi-level signal is large, in a non-linear manner, whereby it is possible to set, in an approximately uniform manner, the respective SN ratios of the intervals between the respective adjoining signal levels of the signal to be determined.

Further, in the case where a light modulated signal is used as the modulated signal 14, a SN ratio of a receiving signal will be determined mainly based on a shot noise as long as a noise caused by the spontaneous emission light or the thermal noise to be used for an optical receiver is sufficiently small. Under such condition, the larger the level of the multi-level signal 13 is, the larger the noise level included in the multi-level signal 13 becomes. Therefore, contrary to the case of FIG. 5, the multi-level encoding section 111 sets the step width small in the range where the level of the multi-level signal 13 is small, and sets the step widths large in the range where the level of the multi-level signal 13 is large, whereby it is possible to set, in an approximately uniform manner, the respective SN ratios of the intervals between the respective adjoining signal levels of the signal to be determined. Accordingly, the quality of the receiving signal at the time of the eavesdropping by the third party is crucially deteriorated in a uniform manner, and it is possible to cause decryption/decoding of the multi-level signal by the third party to be difficult.

### Second Embodiment

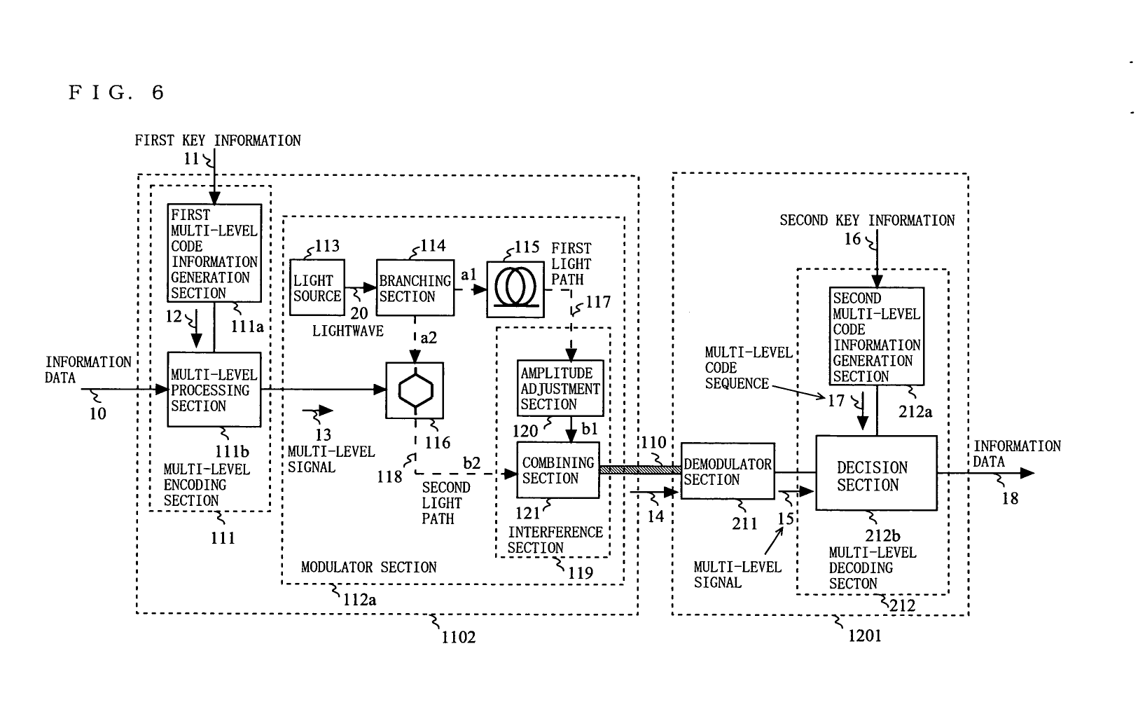

FIG. 6 is a block diagram showing an example of a configuration of a data communication apparatus according to a second embodiment of the present invention. In FIG. 6, the data communication apparatus according to the second embodiment of the present invention has a configuration in which a data transmitting apparatus 1102 and a data receiving apparatus 1201 are connected to each other via a transmission line 110. The data transmitting apparatus 1102 includes a first multi-level code generation section 111a, a multi-level processing section 111b, and a modulator section 112a. The data receiving apparatus 1201 includes a demodulator section 211, a second multi-level code generation section 212a, and a decision section 212b.

As shown in FIG. 6, the configuration of the data communication apparatus according to the second embodiment is different, with regard to a configuration of the modulator section 112a, from the data communication apparatus according to the above-described first embodiment. In FIG. 6, the modulator section 112a includes a light source 113, a branching section 114, a delaying section 115, a light modulator section 116, and an interference section 119. The interference section 119 has an amplitude adjustment section 120 and a combining section 121. Hereinafter, component parts of the configuration which are the same as the first embodiment are provided with common reference characters, and the data communication apparatus according to the second embodiment will be described by mainly focusing such component parts that are different from the first embodiment.

A lightwave 20 emitted from the light source 113 enters into the branching section 114, and in the branching section 114, is branched into a first light path 117 and a second light path 118 mutually having different light path lengths. In the present embodiment, the first light path 117 which passes from the branching section 114 to the interference section 119 via the delaying section 115 is referred to as a long path, and the second light path 118 which passes from the branching section 114 to the interference section 119 via the light modulator section 116 is referred to as a short path.

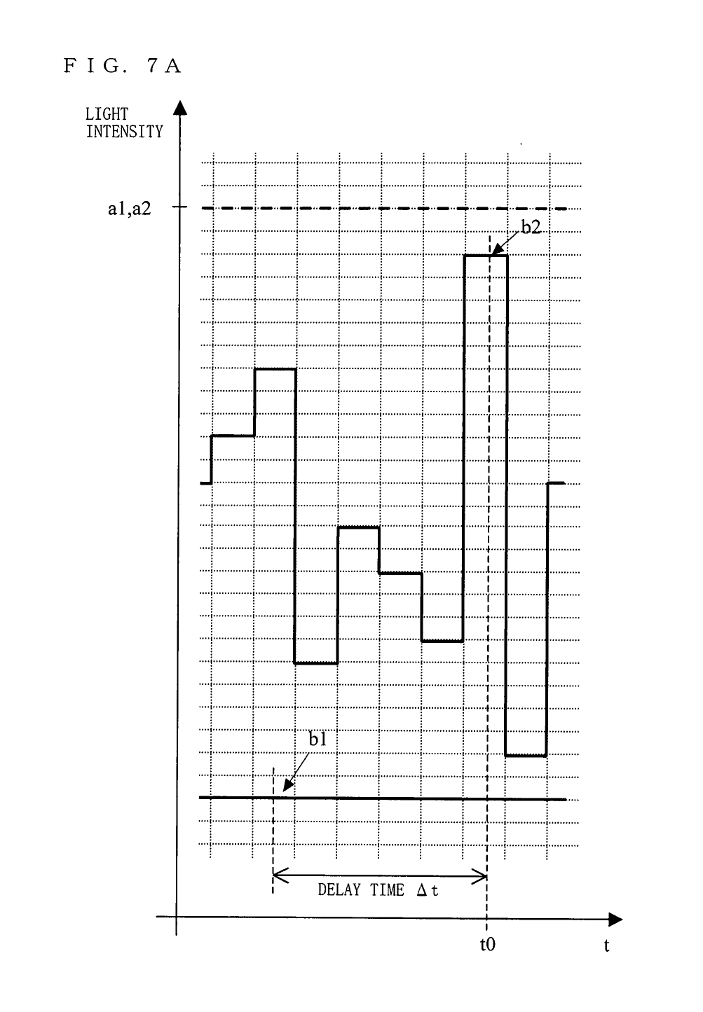

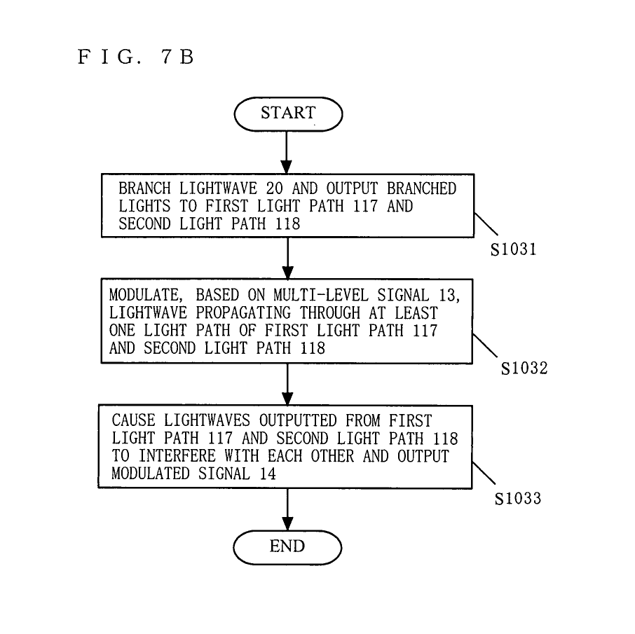

FIG. 7A is a diagram illustrating a waveform of an optical multi-level signal of the data transmitting apparatus 1102 according to the second embodiment of the present invention. With reference to FIG. 7A, a lightwave a1, which is one of lightwaves branched at the branching section 114 and passes through the long path, suffers predetermined delay time Δt in the delaying section 115, and then is emitted to the interference section 119. On the other hand, a lightwave a2, which is branched at the branching section 114 and passes through the short path, is modulated based on the multi-level signal 13 in the light modulator section 116, and then emitted to the interference section 119 as a lightwave b2. The lightwave a1, which is one of the lightwaves emitted to the interference section 119 and passes through the long path, is emitted to the combining section 121 as a lightwave b1 after an amplitude thereof is attenuated to a predetermined amplitude level in the amplitude adjustment section 120. In the combining section 121, the lightwave b1 passed through the long path and the lightwave b2 passed through the short path are combined together, and then sent out to the transmission line 110 as a modulated signal 14.

In the data receiving apparatus 1201, the demodulator section 211 reproduces a multi-level signal 15 by demodulating the modulated signal 14 received via the transmission line 110, and then reproduces information data 18 in a multi-level decoding section 212.

Note that, it is desirable that two lightwaves entered into the combining section 121 have no phase correlation to each other. Such non-correlative relation can be easily realized, in the present embodiment, by setting the light path length in the delaying section 115 equal to or longer than a coherent length of the light source 113.

Further, with regard to configurations of the short path and the long path, in addition to a method in which the delaying section 115 is included in the long path and the light modulator section 116 is included in short path as above described, a method in which the delaying section 115 and the light modulator section 116 are included in the long path may be available. Further, in the present embodiment, the number of branches at the branching section 114 is two, but the number of the branches may be greater than two.

FIG. 7B is a flowchart illustrating an example of an action of the modulator section 112a according to the second embodiment of the present invention. With reference to FIG. 7B, the branching section 114 branches the lightwave 20 outputted from the light source 113 and outputs the branched lights respectively to the first light path 117 and the second light path 118 mutually having different light path lengths (step S1031). The light modulator section 116 modulates, based on the multi-level signal 13, a lightwave propagating on at least one light path between the first light path 117 and the second light path 118 (step S1032). The interference section 119 causes the lightwaves outputted from the first light path 117 and second light path 118 to interfere with each other, and outputs an interfered lightwave as the modulated signal 14 (step S1033).

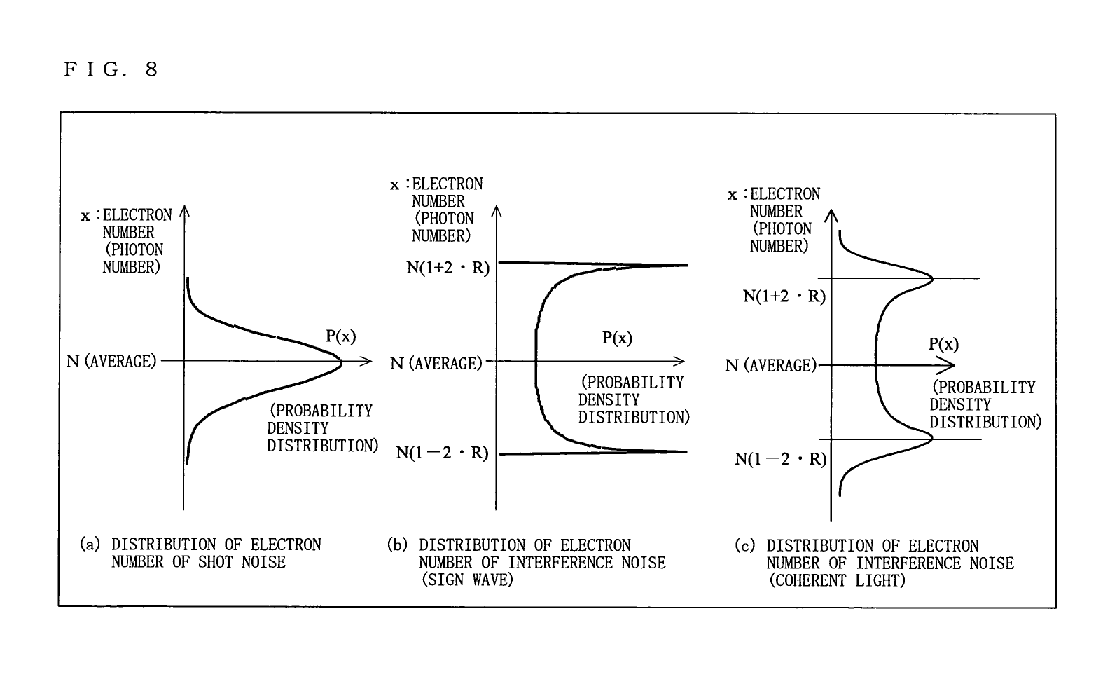

Next, an action of eavesdropping by a third party will be described. The third party performs square detection to a part or a whole of the modulated signal 14 which is a combined wave of two lightwaves passed through the long path and the short path respectively, based on a light receiving element, so as to demodulate the modulated signal 14 into a multi-level signal. A quantum noise and an interference noise of the two lightwaves are overlapped on the demodulated multi-level signal. FIG. 8 is a diagram illustrating overlapped noises caused by the data transmitting apparatus 1102 according to the second embodiment of the present invention.

The quantum noise, which is one of noises overlapped on the multi-level signal, represents a fluctuation inevitably generated when the lightwave is used for the modulated signal, and becomes apparent after detection as a fluctuation of an electron number (that is, a shot noise current) (see FIG. 8(a)). It is known that a distribution of the electron number (that is, an average electron number N) conforms with the Poisson distribution as shown as equation (1).

$$P ( x ) = \frac{{N}^{x}}{x !} {ⅇ}^{- N} \qquad equation ( 1 )$$

Further, among noises overlapped on the multi-level signal, interference between two lightwaves (respectively having a common wave length), which travel in a common direction and are not in a correlative relation, becomes apparent after detection as the interference noise representing a polarized distribution having the average electron number N as a center thereof (FIG. 8(b)). A probability density function in the case where the interference noise is standardized by the average electron number N is expressed as equation (2) in which an electric field amplitude ratio of the both lightwaves is represented by R. Particularly, two poles in an amplitude distribution of the interference noise (in other words, the electron number generated with the highest frequency in the case where the average electron number is set to N) are represented as N(1−2R) and N(1+2R). Therefore, a difference between the two poles (N·4R) is determined by the average electron number N and the electric field amplitude ratio of the both lightwaves.

$$P ( x ) = \frac{1}{2 π \cdot R \cdot \sqrt{1 - {( \frac{x - 1}{2 R} )}^{2}}} \qquad equation ( 2 )$$

That is, the distribution of the electron number after detection by the eavesdropper, i.e. by the third party, is polarized, due to the interference noise, with the average electron number N set as the center thereof, and due to the shot noise, the polarized distribution forms respective peaks curving down both sides thereof. (FIG. 8(c)). It is difficult to avoid such overlapped noises before/after detection due to inevitability of the quantum noise and difficulty of separation/elimination of the interference noise. Further, as shown in equation (2), the distribution of the noises which become apparent after detection depends on the average electron number N which is proportional to a signal light intensity and on the electric field amplitude ratio R of the two lightwaves. Therefore, it is possible to set freely an overlap level of the noises which are difficult to avoid by setting the electric field amplitude ratio R. Note that the setting of the electric field amplitude ratio R can be easily realized by setting, for example, a ratio of combination of the two lightwaves in the combining section 121.

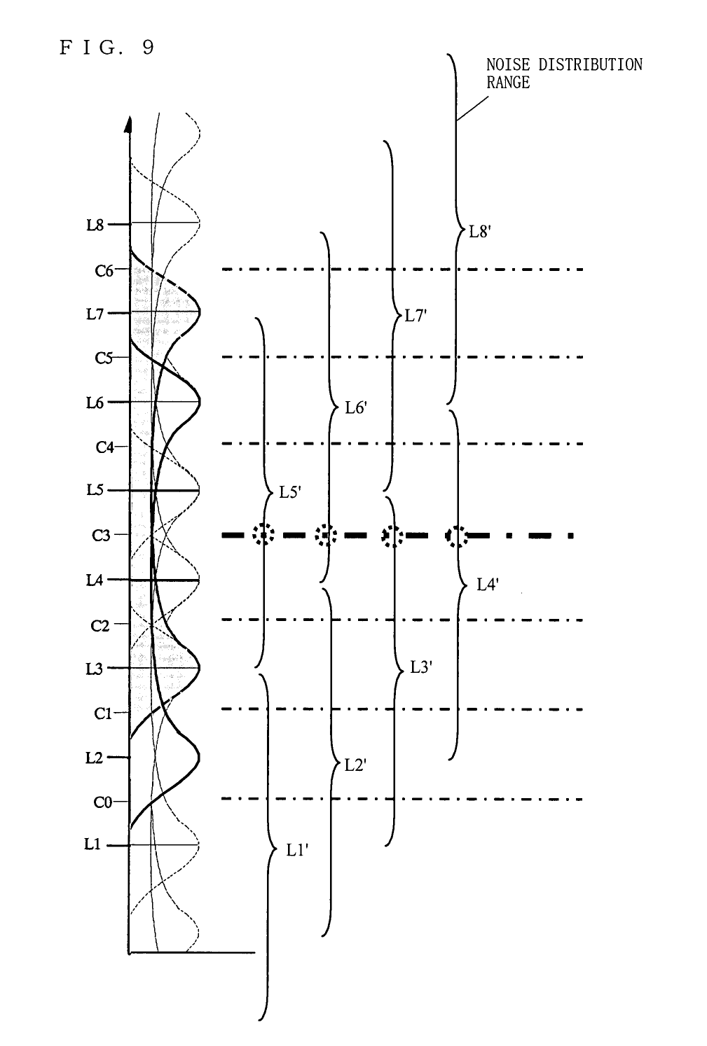

Next, the third party, that is the eavesdropper, performs, based on the all-possible attacks, simultaneous determination of the multi-level signal by preparing the thresholds corresponding to all possible intervals between the signal levels which the multi-level signal 15 may take, and attempts extraction of correct key information or information data by analyzing a result of the simultaneous determination. For example, the eavesdropper identifies the level of the multi-level signal by performing the multi-level determination of the multi-level signal using the levels c0/c1/c2/c3/c4/c5/c6 of the multi-level code sequence, as shown in FIG. 9, as the thresholds. However, as above described, noises which are difficult to avoid before/after detection are overlapped, and consequently such noises that are polarized with respective multi-levels as centers thereof are overlapped on the multi-level signal in an approximately uniform manner. For example, as a result of a determination performed with respect to level c3 of the multi-level code sequence, a possibility of multi-levels of L3/L6 as well as a possibility of multi-levels of adjoining L4/L5 may be considered, and consequently identification error in the multi-level determination by the eavesdropper will be induced, specification of the multi-level based on an analysis of the result of the determination will become further difficult, whereby it is possible to cause eavesdropping to be difficult.

As above described, according to the present embodiment, a modulated signal, which is a combined signal of two lightwaves passed through a long path and a short path, is sent out, whereby it is possible to generate a noise, which is difficult to avoid before/after detection and excels in controllability, significantly deteriorate quality of a receiving signal at the time of eavesdropping by a third party, and provide a safe data communication apparatus which causes decryption/decoding of the multi-level signal to be difficult.

### Third Embodiment

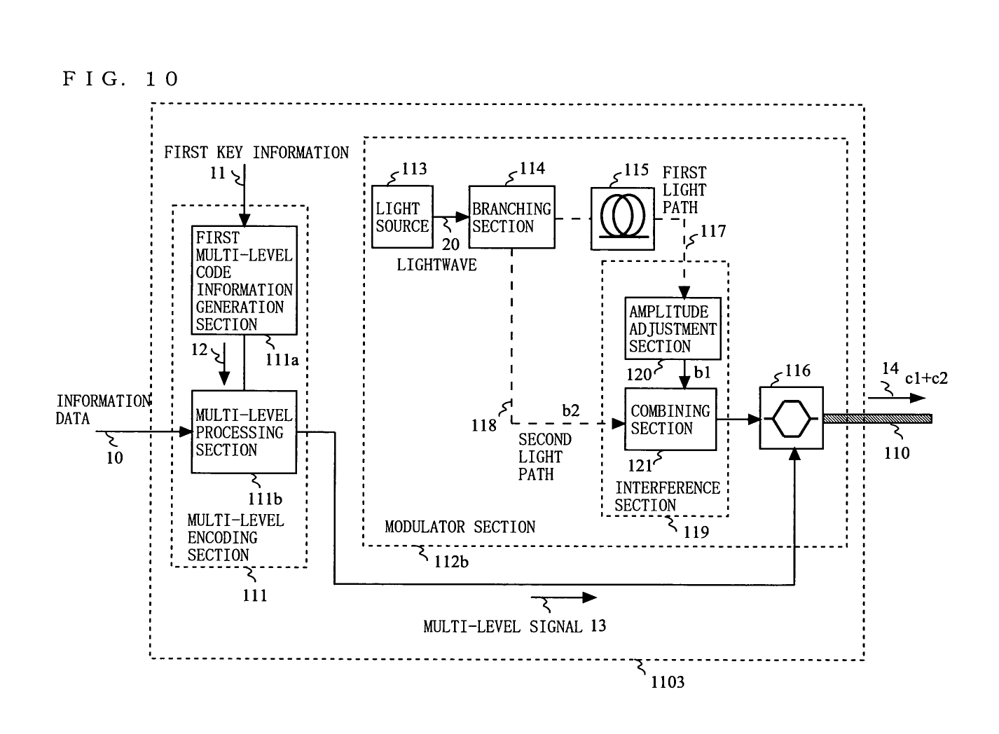

FIG. 10 is a block diagram showing an example of a configuration of a data transmitting apparatus 1103 according to a third embodiment of the present invention. As shown in FIG. 10, the data transmitting apparatus 1103 according to the third embodiment is different, with regard to a configuration of a modulator section 112b, from the data transmitting apparatus 1101 according to the above-described first embodiment. Hereinafter, component parts of the configuration which are the same as the first embodiment are provided with common reference characters, and the data communication apparatus according to the third embodiment will be described by mainly focusing such component parts that are different from the first embodiment.

In FIG. 10, the modulator section 112b includes a light source 113, a branching section 114, an delaying section 115, a light modulator section 116, and an interference section 119. The interference section 119 has an amplitude adjustment section 120 and a combining section 121. In the modulator section 112b, a lightwave 20 emitted from the light source 113 enters into the branching section 114, and is branched, in the branching section 114, into a first light path 117 and a second light path 118 having different light path lengths. In the present embodiment, the first light path 117 which passes from the branching section 114 to the interference section 119 via the delaying section 115 is referred to as a long path, and the second light path 118 which directly connects the branching section 114 and the interference section 119 is referred to as a short path.

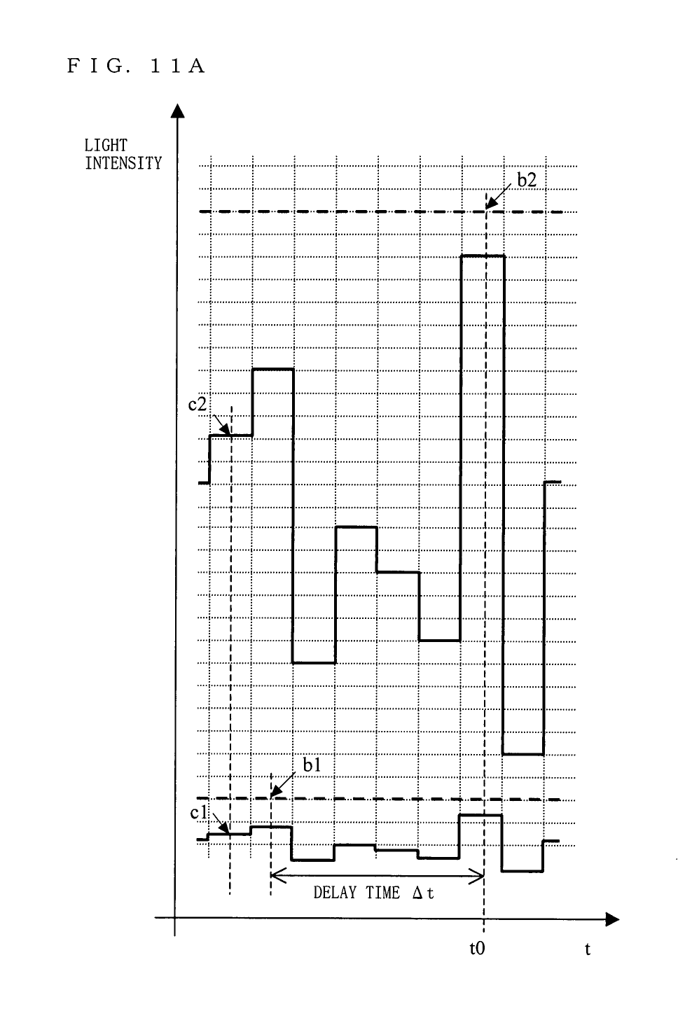

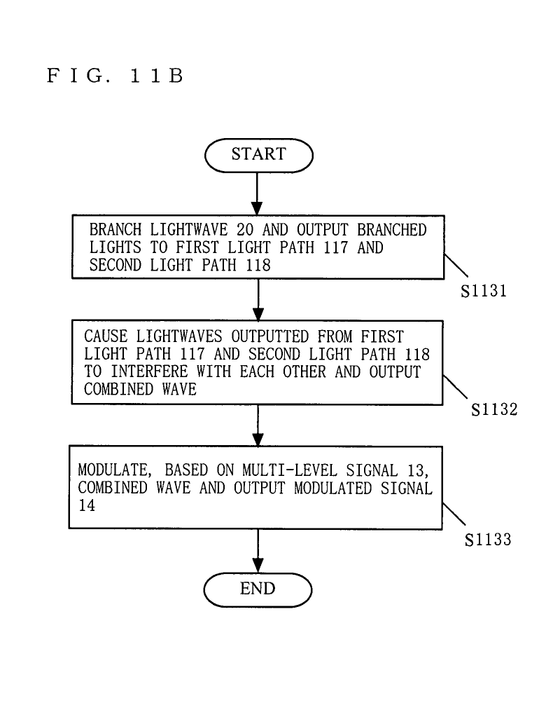

FIG. 11A is a diagram illustrating allocations of wavelengths of an optical multi-level signal of the data transmitting apparatus 1103 according to the third embodiment of the present invention. With reference to FIG. 11A, a lightwave, which is one of lightwaves branched at the branching section 114 and passes through the long path, suffers predetermined delay time Δt the delaying section 115, and then is emitted to the interference section 119. On the other hand, a lightwave b2, which is branched at the branching section 114 and passes through the short path, is emitted to the interference section 119. The lightwave, which is one of the lightwaves emitted to the interference section 119 and passes through the long path, is emitted as a lightwave b1 to the combining section 121 after an amplitude thereof is attenuated to a predetermined amplitude level in the amplitude adjustment section 120. The lightwave b1 passed though the long path and the lightwave b2 passed through the short path are combined together in the combining section 121, modulated all together, based on the multi-level signal 13, in the light modulator section 116, and then sent out to the transmission line 110 as a modulated signal 14 (c1+c2).

FIG. 11B is a flowchart illustrating an example of an action of the modulator section 112b according to the third embodiment of the present invention. With reference to FIG. 11B, the branching section 114 branches the lightwave 20 outputted from the light source 113, and outputs the respective branched lights to the first light path 117 and the second light path 118 respectively having different light path lengths (step S1131). The interference section 119 causes the lightwaves respectively outputted from the first light path 117 and the second light path 118 to interfere with each other, and outputs an interfered lightwave as a combined wave (step S1132). The light modulator section 116 modulates the combined wave outputted from the interference section 119, based on the multi-level signal 13, and then outputs the modulated combined wave as the modulated signal 14 (step S1133).

As above described, according to the present embodiment, the combined wave of two lightwaves passed through the long path and the short path is modulated all together based on the multi-level signal, and consequently it is possible to fix an electric field amplitude ratio R of the two lightwaves included in the modulated signal without depending on a signal stream of the multi-level signal, whereby it becomes easy to control a noise overlapped on the multi-level signal at the time of demodulation of the modulated signal. Further, since it is difficult to avoid the overlapped noise after/before detection due to inevitability of a quantum noise and difficulty in separation/elimination of an interference noise, an identification error in the multi-level determination action by the eavesdropper will be induced, and specification of the multi-level based on an analysis of the result of the determination will become further difficult, whereby it is possible to cause eavesdropping to be difficult.

### Fourth Embodiment

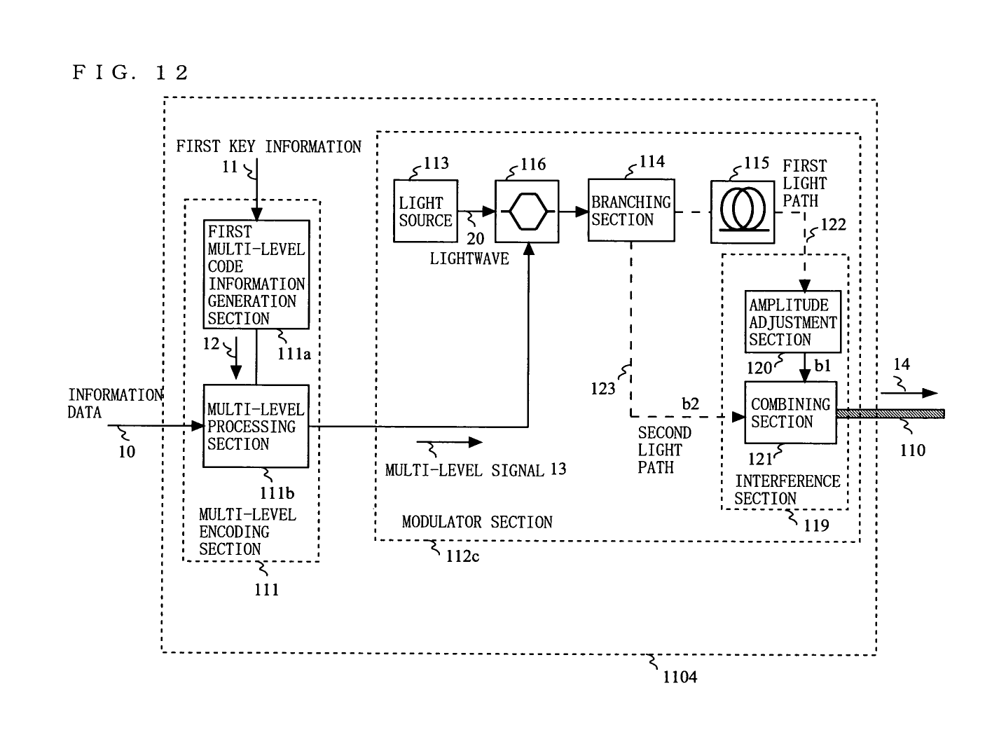

FIG. 12 is a block diagram showing an example of a configuration of a data transmitting apparatus 1104 according to a fourth embodiment of the present invention. As shown in FIG. 12, the data transmitting apparatus 1104 according to the fourth embodiment of the present invention is different, with regard to a configuration of a modulator section 112c, from the data transmitting apparatus 1101 of the first embodiment. Hereinafter, component parts of the configuration which are the same as the first embodiment are provided with common reference characters, and the data communication apparatus according to the fourth embodiment will be described by mainly focusing such component parts that are different from the first embodiment.

In FIG. 12, the modulator section 112c includes a light source 113, a branching section 114, a delaying section 115, a light modulator section 116, and an interference section 119. The interference section 119 has an amplitude adjustment section 120 and a combining section 121. In the modulator section 112c, a lightwave 20 emitted from the light source 113 enters into the light modulator section 116, is modulated based on the multi-level signal 13 in the light modulator section 116, branched at the branching section 114 into a first light path 122 and a second light path 123 having different light path lengths, and then emitted. In the present embodiment, the first light path 122 which passes from the branching section 114 to the interference section 119 via the delaying section 115 is referred to as a long path, and the second light path 123 which directly connects the branching section 114 and the interference section 119 is referred to as a short path.

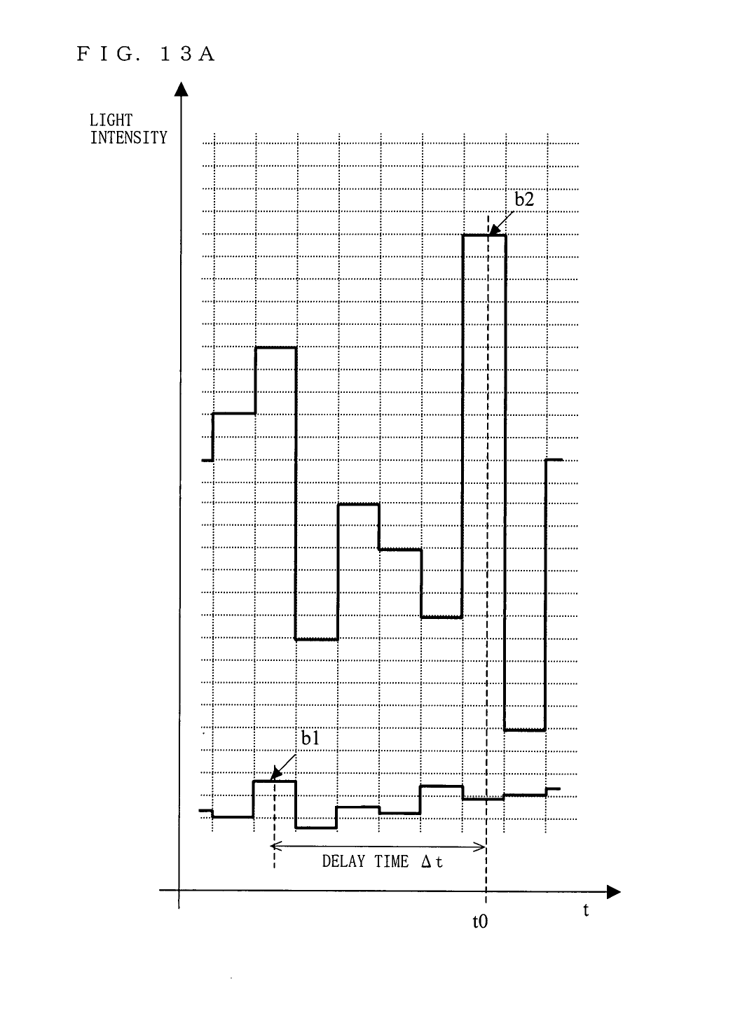

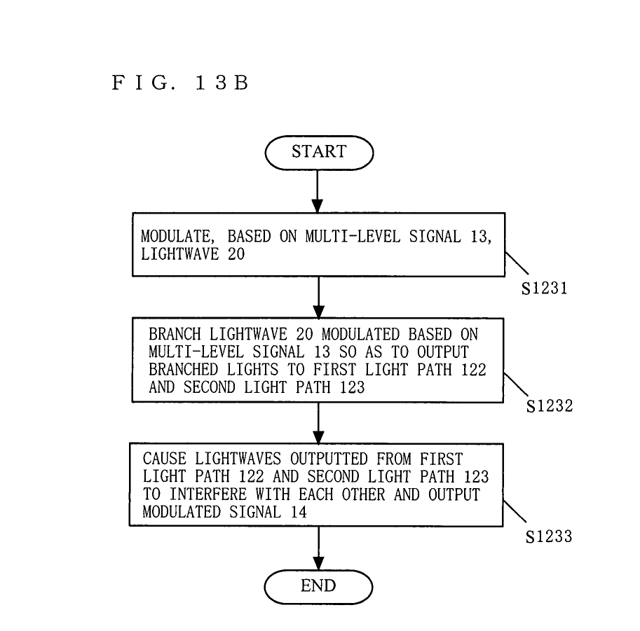

FIG. 13A is a diagram illustrating allocations of wavelengths of an optical multi-level signal of the data transmitting apparatus 1104 according to the fourth embodiment of the present invention. With reference to FIG. 13A, the lightwave, which is one of lightwaves branched at the branching section 114 and passes through the long path, suffers predetermined delay time Δt the delaying section 115, and is then emitted to the interference section 119. On the other hand, a lightwave b2 which is branched at the branching section 114 and passes through the short path is emitted to the interference section 119. The lightwave, which is one of lightwaves emitted to the interference section 119 and passes through the long path, is emitted as a lightwave b1 to the combining section 121 after an amplitude thereof is attenuated to a predetermined amplitude level in the amplitude adjustment section 120. The lightwave b1 passed though the long path and the lightwave b2 passed through the short path are combined together in the combining section 121, and then sent out as a modulated signal 14 to a transmission line 110.

FIG. 13B is a flowchart illustrating an example of an action of the modulator section 112c according to the fourth embodiment of the present invention. With reference to FIG. 13B, the light modulator section 116 modulates, based on the multi-level signal 13, the lightwave 20 outputted from the light source 113 (step S1231). The branching section 114 branches the lightwave 20 modulated based on the multi-level signal 13, and outputs the respective branched lights to the first light path 117 and the second light path 118 respectively having different light path lengths (step S1232). The interference section 119 causes the lightwaves respectively outputted from the first light path 117 and the second light path 118 to interfere with each other, and outputs an interfered lightwave as a modulated signal (step S1233).

As above described, according to the present embodiment, the lightwave is modulated previously based on the multi-level signal, and then the branched lightwaves are provided with light paths having different path lengths, whereby it is possible to approximately randomize an electric field amplitude ratio R of the two lightwaves. Accordingly it is possible to make it difficult for a third party to perform a quantitative prediction of a noise which becomes apparent after detection. Further, it is difficult to avoid the overlapped noise after/before detection due to inevitability of a quantum noise and difficulty in separation/elimination of an interference noise. As a result, an identification error at the time of multi-level determination by the eavesdropper will be induced, specification of the multi-level based on an analysis of a result of determination will become further difficult, and consequently it is possible to cause eavesdropping to be difficult.

### Fifth Embodiment

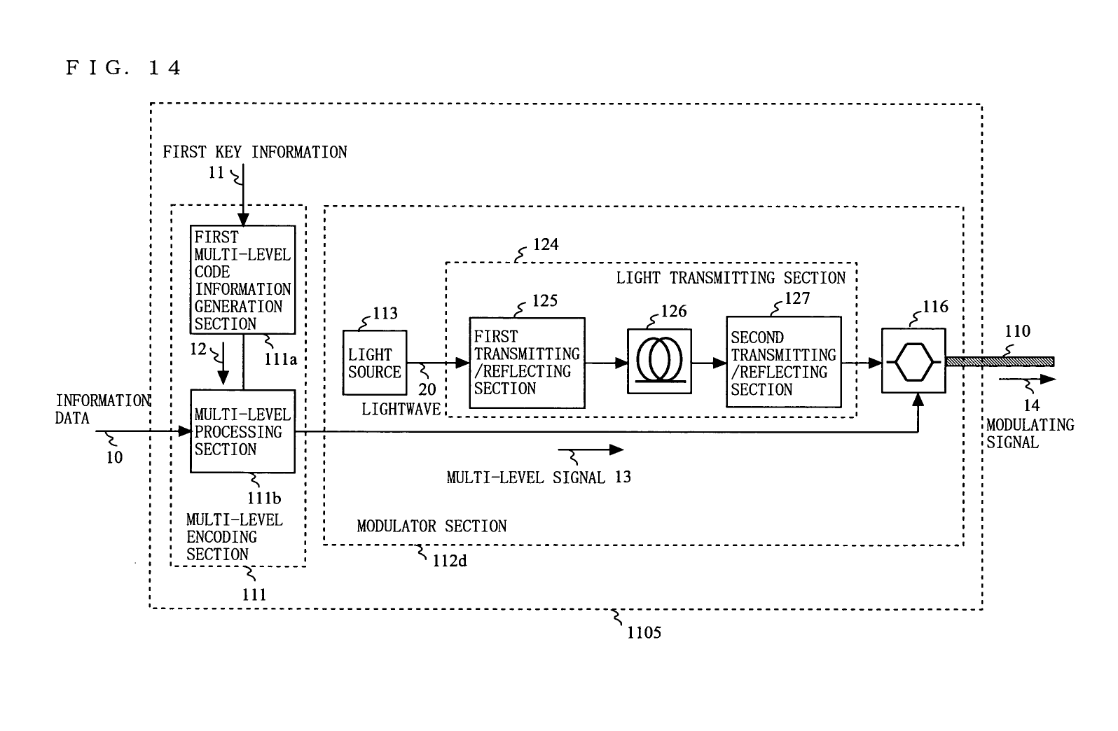

FIG. 14 is a block diagram showing an example of a configuration of a data transmitting apparatus 1105 according to a fifth embodiment of the present invention. As shown in FIG. 14, the data transmitting apparatus 1105 according to fifth embodiment of the present invention is different, with regard to a configuration of a modulator section 112d, from the data transmitting apparatus according to the first embodiment. Hereinafter, component parts of the configuration which are the same as the first embodiment are provided with common reference characters, and the data communication apparatus according to the fifth embodiment will be described by mainly focusing such component parts that are different from the first embodiment.

In FIG. 14, the modulator section 112d includes a light source 113, a light transmitting section 124, and a light modulator section 116. The light transmitting section 124 has a first transmitting/reflecting section 125, and a second transmitting/reflecting section 127, and a light path 126 having a predetermined light path length. The first transmitting/reflecting section 125 and the second transmitting/reflecting section 127 causes the lightwave 20 inputted from a light source 113 to transmit at a predetermined transmission factor and to reflect at a predetermined reflection factor.

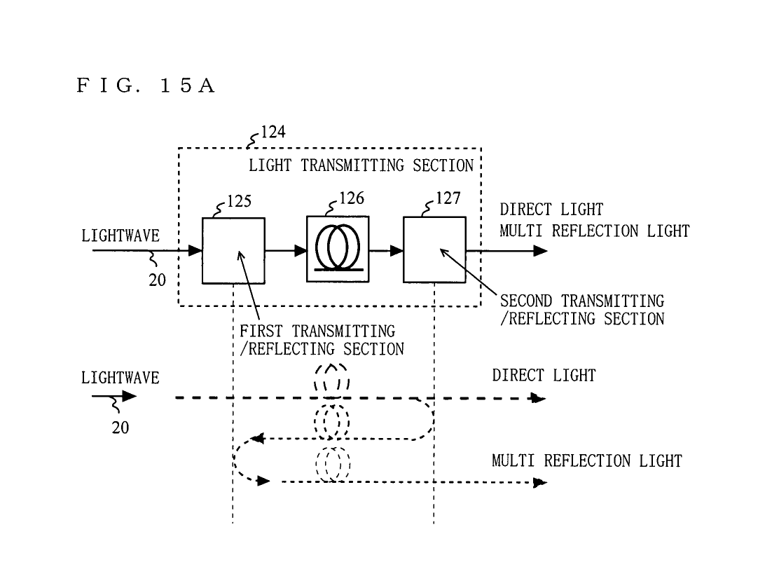

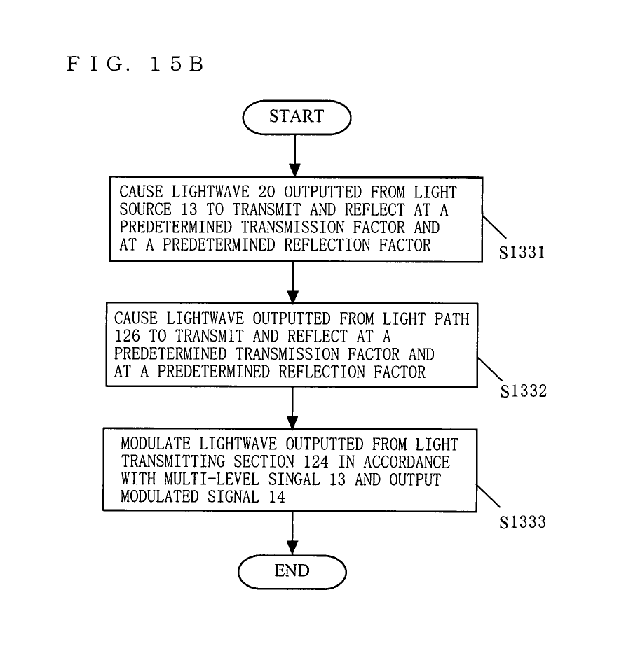

FIG. 15A is a diagram illustrating a flow of the lightwave in the light transmitting section 124. With reference to FIG. 14 and FIG. 15A, the lightwave 20 emitted from the light source 113 enters into the light transmitting section 124, and is caused to transmit at the first transmitting/reflecting section 125 in the light transmitting section 124, and emitted to the second transmitting/reflecting section 127 via the light path 126. A portion of the lightwave entered into the second transmitting/reflecting section 127 is caused to transmit based on the transmission factor retained by the second transmitting/reflecting section 127, and enters into the light modulator section 116. In the present embodiment, the lightwave directly outputted via the first transmitting/reflecting section 125, the light path 126, and the second transmitting/reflecting section 127 is referred to as a direct light.

On the other hand, a portion of the lightwave entered into the second transmitting/reflecting section 127 is caused to reflect based on the reflection factor retained by the second transmitting/reflecting section 127, propagated through the light path 126 in a reverse direction, caused to reflect again, at the first transmitting/reflecting section 125, based on the reflection factor retained by the first transmitting/reflecting section 125, and then enters into the light modulator section 116 via the light path 126 and the second transmitting/reflecting section 127. In the present embodiment, the lightwave, which passes through the first transmitting/reflecting section 125, the light path 126, and the second transmitting/reflecting section 127 twice respectively and is then emitted, is referred to as a multi-reflected light.

For the sake of simplification, description of a higher-order reflection will be omitted. Here, a difference in the light path length between two lightwaves (the direct light and the multi-reflected light) is exactly equivalent to a round-trip of the light path 126 (twice as long as the light path length of the light path 126). Further, assuming that the reflection factor retained by the first transmitting/reflecting section 125 is R₁₂₅, and the reflection factor retained by the second transmitting/reflecting section 127 is R₁₂₇, an electric field amplitude ratio R is fixed by R=R₁₂₅·R₁₂₇.

In the present embodiment, the light transmitting section 124 includes the two transmitting/reflecting sections and light paths allocated between the two transmitting/reflecting sections, and the electric field amplitude ratio R is provided based on the reflection factors retained by the two transmitting/reflecting sections. However, it may be possible to provide a given electric field amplitude ratio between the direct light and the multi-reflected light by, for example, giving a light loss to the direct light and the multi-reflected light passing though the light paths in the light transmitting section.

The direct light and the multi-reflected light entered into the light modulator section 116 are modulated all together, based on the multi-level signal 13, in the light modulator section 116, and sent out to the transmission line 110 as a modulated signal 14.

FIG. 15B is a flowchart illustrating an example of an action of the modulator section 112d according to the fifth embodiment of the present invention. With reference to FIG. 15B, the light transmitting section 124 causes the lightwave 20 outputted from the light source 113 to transmit. Specifically, in the light transmitting section 124, the first transmitting/reflecting section 125 causes the lightwave 20 outputted from the light source 113 to transmit at a predetermined transmission factor and to reflect at a predetermined reflection factor (step S1331). Further, the second transmitting/reflecting section 127 causes the lightwave outputted from the light path 126 to transmit at a predetermined transmission factor and to reflect at a predetermined reflection factor (step S1332). The light modulator section 116 modulates the lightwave outputted from the light transmitting section 124, based on the multi-level signal 13, and outputs the modulated lightwave as a modulated signal 14 (step S1333).

As above described, according to the present embodiment, two transmitting/reflecting sections are included in light paths, and two lightwaves (the direct light and the multi-reflected light), which pass though the light paths having different light path lengths, are modulated all together based on the multi-level signal, and consequently it is possible to fix, in a further simple manner, an electric field amplitude ratio R of the two lightwaves included in the modulated signal without depending on a signal stream of the multi-level signal. Further, it is difficult to avoid an overlapped noise after/before detection due to inevitability of a quantum noise and difficulty in separation/elimination of an interference noise. As a result, an identification error at the time of multi-level determination by the eavesdropper will be induced, and specification of the multi-level based on an analysis of a result of determination will become further difficult, whereby it is possible to cause eavesdropping to be difficult.

### Sixth Embodiment

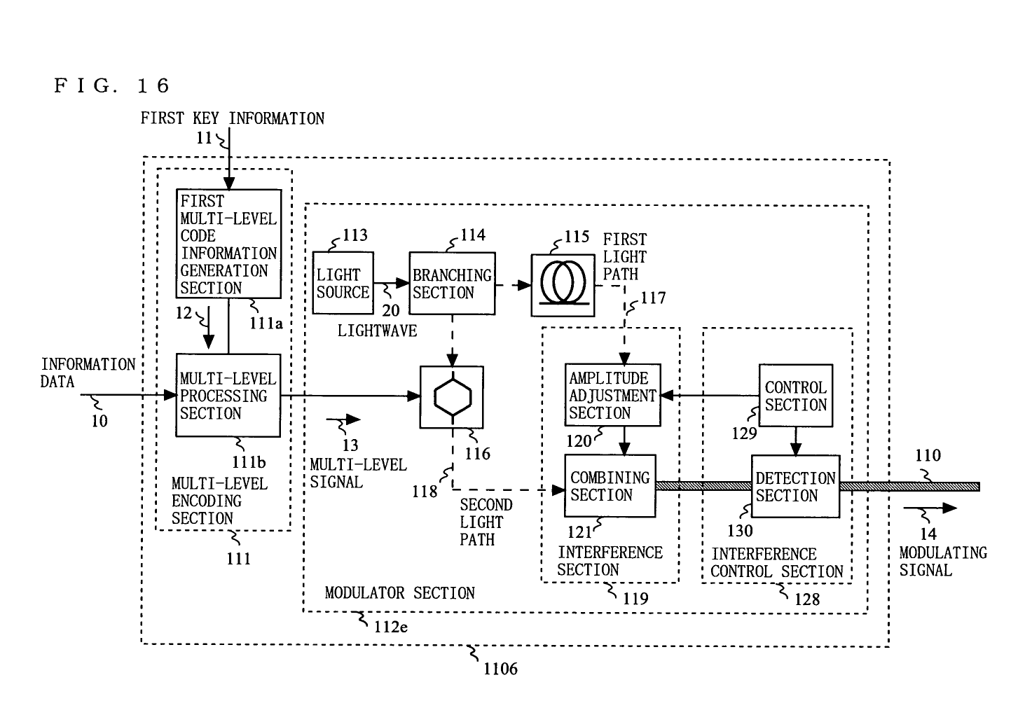

FIG. 16 is a block diagram showing an example of a configuration of a data transmitting apparatus 1106 according to a sixth embodiment of the present invention. As shown in FIG. 16, the data transmitting apparatus 1106 according to the sixth embodiment is different, with regard to a configuration of a modulator section 112e, from the data transmitting apparatus according to the first embodiment. Hereinafter, component parts of the configuration which are the same as the first embodiment are provided with common reference characters, and the data communication apparatus according to the fifth embodiment will be described by mainly focusing such component parts that are different from the first embodiment.

In FIG. 16, the modulator section 112e includes a light source 113, a branching section 114, a delaying section 115, a light modulator section 116, an interference section 119 and an interference control section 128. The interference control section 128 has a control section 129 and a detection section 130. Note that the interference section 119 may be of such a configuration that includes an amplitude adjustment section 120 and a combining section 121, as shown in FIG. 16.

With reference to FIG. 16, the lightwave 20 emitted from the light source 113 enters into the branching section 114, and is branched, at the branching section 114, into a first light path 117 and a second light path 118 having different light path lengths, and then emitted. In the present invention, the first light path 117 which passes from the branching section 114 to the interference section 119 via the delaying section 115 is referred to as a long path, and the second light path 118 which passes from the branching section 114 to the interference section 119 via the light modulator section 116 is referred to as a short path.

A lightwave which is one of lightwaves branched at the branching section 114 and passes through the long path suffers predetermined delay in the delaying section 115, and is then emitted to the interference section 119. On the other hand, a lightwave, which is branched at the branching section 114 and passes through the short path, is modulated based on the multi-level signal 13 in the light modulator section 116, and then emitted to the interference section 119. A lightwave, which is one of the lightwaves emitted to the interference section 119 and passes through the long path, enters into the combining section 121 after an amplitude thereof is attenuated, in the amplitude adjustment section 120, to a predetermined amplitude level in accordance with a control signal outputted from the control section 129. In the combining section 121, the lightwave passed through the long path and the lightwave passed through the short path are combined together and enter into the detection section 130.

The detection section 130 detects a level of an overlapped noise included in such entered signal, and outputs a result of the detection to the control section 129, and also sends a modulated signal 14 out to the transmission line 110. The control section 129 performs, based on the result of the detection, a feedback control on an attenuation level of an amplitude in the amplitude adjustment section 120 such that the overlapped noise included in the modulated signal 14 is kept constant, and indirectly causes an electric field amplitude ratio R of two lightwaves in the combining section 121 to be varied. Accordingly, regardless of a change in an operational environment, it is possible to constantly generate the overlapped noise when an eavesdropper demodulates the modulated signal.

In the present embodiment, the electric field amplitude ratio R is indirectly controlled by controlling the attenuation level of the amplitude in the amplitude adjustment section 120, however, it may possible to control the electric field amplitude ratio R by controlling, for example, polarization of the two lightwaves entering into the combining section 121.

Further, in the present embodiment, the detection section 130 is allocate data stage after the combining section 121, but may be allocated at any position as long as the detection section 130 is in a light path in which the two lightwaves are combined together.

As above described, according to the present embodiment, it is possible to generate a noise, which is difficult to avoid before/after detection, by sending out the modulated signal which is a combined wave of the two lightwaves respectively passed through the long path and the short path. Accordingly, quality of the receiving signal at the time of the eavesdropping by the third party is crucially deteriorated, whereby it is possible to provide a further safe data communication apparatus which causes decryption/decoding of the multi-level signal by the third party to be difficult.

Note that each of the data communication apparatuses according to the first to sixth embodiments may have a configuration which combines features of the remaining embodiments. Further, processing performed by each of the data transmitting apparatuses, the data receiving apparatuses, and the data communication apparatuses according to the above-described first to sixth embodiments may be respectively regarded as a data transmitting method, a data receiving method, and a data communication method, each of which cause a series of processing procedure to be executed.

Further, the above-described data transmitting method, the data receiving method, and the data communication method may be realized by causing a CPU to interpret and execute predetermined program data which is capable of executing the above-described processing procedure stored in a storage device (such as a ROM, a RAM, and a hard disk). In such case, the program data may be executed after being stored in the storage device via a storage medium, or may be executed directory from the storage medium. Note that the storage medium includes a ROM, a RAM, a semiconductor memory such as a flash memory, a magnetic disk memory such as a flexible disk and a hard disk, an optical disk such as a CD-ROM, a DVD, and a BD, a memory card, or the like. Further, the storage medium is a notion including a communication medium such as a telephone line and a carrier line.

The data communication apparatus according to the present invention is useful as a safe secret communication apparatus which is unsusceptible to eavesdropping/interception.

While the invention has been described in detail, the foregoing description is in all aspects illustrative and not restrictive. It is understood that numerous other modifications and variations can be devised without departing from the scope of the invention.

What is claimed is:

1. A data transmitting apparatus for encrypting information data by using predetermined key information and performing secret communication with a receiving apparatus, the data transmitting apparatus comprising:
a multi-level code generation section for generating, based on the predetermined key information, a multi-level code sequence in which a signal level changes so as to be approximately random numbers;
a multi-level processing section for combining the multi-level code sequence and the information data, and generating a multi-level signal having a plurality of levels corresponding to a combination of the multi-level code sequence and the information data; and
a modulator section for modulating the multi-level signal based on predetermined modulation processing and outputting a modulated signal, wherein
the modulator section includes:
a branching section for branching a lightwave outputted from a light source, and outputting respective branched lights to a first light path and a second light path respectively having different light path lengths;
a light modulator section for modulating, based on the multi-level signal, a lightwave propagating through at least one light path of the first light path and the second light path; and
an interference section for causing lightwaves, which are outputted from the first light path and the second light path, to interfere with each other, and outputting an interfered lightwave as the modulated signal.

2. A data transmitting apparatus for encrypting information data by using predetermined key information and performing secret communication with a receiving apparatus, the data transmitting apparatus comprising:
a multi-level code generation section for generating, based on the predetermined key information, a multi-level code sequence in which a signal level changes so as to be approximately random numbers;
a multi-level processing section for combining the multi-level code sequence and the information data, and generating a multi-level signal having a plurality of levels corresponding to a combination of the multi-level code sequence and the information data; and
a modulator section for modulating the multi-level signal based on predetermined modulation processing and outputting a modulated signal, wherein
the modulator section includes:
a branching section for branching a lightwave outputted from a light source, and outputting respective branched lights to a first light path and a second light path respectively having different light path lengths;
an interference section for causing lightwaves, which are outputted from the first light path and the second light path, to interfere with each other, and outputting an interfered lightwave as a combined wave; and
a light modulator section for modulating, based on the multi-level signal, the combined wave outputted from the interference section.

3. A data transmitting apparatus for encrypting information data by using predetermined key information and performing secret communication with a receiving apparatus, the data transmitting apparatus comprising:
a multi-level code generation section for generating, based on the predetermined key information, a multi-level code sequence in which a signal level changes so as to be approximately random numbers;
a multi-level processing section for combining the multi-level code sequence and the information data, and generating a multi-level signal having a plurality of levels corresponding to a combination of the multi-level code sequence and the information data; and
a modulator section for modulating the multi-level signal based on predetermined modulation processing and outputting a modulated signal, wherein
the modulator section includes:
a light modulator section for modulating, based on the multi-level signal, a lightwave outputted from a light source;
a branching section for branching an output from the light modular section, and outputting respective branched lights to a first light path and a second light path respectively having different light path lengths; and
an interference section for causing lightwaves, which are outputted from the first light path and the second light path, to interfere with each other, and outputting an interfered lightwave as the modulated signal.

4. A data transmitting apparatus for encrypting information data by using predetermined key information and performing secret communication with a receiving apparatus, the data transmitting apparatus comprising:
a multi-level code generation section for generating, based on the predetermined key information, a multi-level code sequence in which a signal level changes so as to be approximately random numbers;
a multi-level processing section for combining the multi-level code sequence and the information data, and generating a multi-level signal having a plurality of levels corresponding to a combination of the multi-level code sequence and the information data; and
a modulator section for modulating the multi-level signal based on predetermined modulation processing and outputting a modulated signal, wherein
the modulator section includes:
a light transmitting section which is allocated on a propagation path of a lightwave outputted from a light source; and
a light modulator section for modulating, based on the multi-level signal, a lightwave outputted from the light transmitting section,
the light transmitting section includes:
a first transmitting/reflecting section for causing the lightwave outputted from the light source to transmit at a predetermined transmission factor and to reflect at a predetermined reflection factor, respectively;
a second transmitting/reflecting section for causing a lightwave outputted from the first transmitting/reflecting section to transmit at a predetermined transmission factor and to reflect at a predetermined reflection factor, respectively; and
a light path which has a predetermined light path length and is allocated between the first transmitting/reflecting section and the second transmitting/reflecting section.

5. The data transmitting apparatus according to claim 1, wherein a difference in the light path lengths between the first light path and the second light path is equal to or longer than a coherent length of a lightwave to be inputted to the modulator section.

6. The data transmitting apparatus according to claim 1, wherein a difference in the light path lengths between the first light path and the second light path is generated in a delaying section which is allocated on at least one of the first light path and the second light path.

7. The data transmitting apparatus according to claim 1, wherein the interference section includes:
an amplitude adjustment section for attenuating an amplitude of the lightwave propagating through at least one light path of the first light path and the second light path; and
a combining section for combining the lightwaves outputted from the first light path and the second light path.

8. The data transmitting apparatus according to claim 1, wherein the interference section includes:
a polarization adjustment section for adjusting polarization of the lightwave propagating through at least one light path of the first light path and the second light path; and
a combining section for combining the lightwaves outputted from the first light path and the second light path.

9. The data transmitting apparatus according to claim 7, wherein the amplitude adjustment section varies, based on a control signal inputted externally, an attenuation level of a lightwave to be inputted.

10. The data transmitting apparatus according to claim 8, wherein the polarization adjustment section varies, based on a control signal inputted externally, the polarization of a lightwave to be inputted.

11. The data transmitting apparatus according to claim 4, wherein a light path length of the light path having the predetermined light path length is equal to or more than 0.5 times of a coherent length of the lightwave outputted from the light source.

12. The data transmitting apparatus according to claim 2, wherein the modulator section further includes an interference control section for performing a feedback control of a ratio of the combined wave in the interference section in accordance with a level of an interference noise included in a lightwave outputted from at least either of the interference section or the light modulator section.

13. The data transmitting apparatus according to claim 12, wherein the interference control section includes:
a detection section for performing a photoelectric conversion of a lightwave to be inputted and detecting the interference noise; and
a control section for outputting, based on a result of detection by the detection section, a control signal to the interference section.

14. A data transmitting method for encrypting information data by using predetermined key information and performing secret communication with a receiving apparatus, the data transmitting method comprising:
a multi-level code generation step of generating, based on the predetermined key information, a multi-level code sequence in which a signal level changes so as to be approximately random numbers;
a multi-level processing step of combining the multi-level code sequence and the information data, and generating a multi-level signal having a plurality of levels corresponding to a combination of the multi-level code sequence and the information data; and
a modulation step of modulating the multi-level signal based on predetermined modulation processing and outputting a modulated signal, wherein
the modulation step includes:
a branching step of branching a lightwave outputted from a light source, and outputting respective branched lights to a first light path and a second light path respectively having different light path lengths;
a light modulation step of modulating, based on the multi-level signal, a lightwave propagating through at least one light path of the first light path and the second light path; and
an interfering step of causing the lightwaves, which are outputted from the first light path and the second light path, to interfere with each other, and outputting an interfered lightwaves as the modulated signal.

15. A data transmitting method for encrypting information data by using predetermined key information and performing secret communication with a receiving apparatus, the data transmitting method comprising:
a multi-level code generation step of generating, based on the predetermined key information, a multi-level code sequence in which a signal level changes so as to be approximately random numbers;
a multi-level processing step of combining the multi-level code sequence and the information data, and generating a multi-level signal having a plurality of levels corresponding to a combination of the multi-level code sequence and the information data; and
a modulation step of modulating the multi-level signal based on predetermined modulation processing and outputting a modulated signal, wherein
the modulation step includes:
a branching step of branching a lightwave outputted from a light source, and outputting respective branched lights to a first light path and a second light path respectively having different light path lengths;
an interfering step of causing lightwaves, which are outputted from first light path and the second light path, to interfere with each other, and outputting an interfered lightwaves as a combined wave; and
a light modulation step of modulating, based on the multi-level signal, the combined wave.

16. A data transmitting method for encrypting information data by using predetermined key information and performing secret communication with a receiving apparatus, the data transmitting method comprising:
a multi-level code generation step of generating, based on the predetermined key information, a multi-level code sequence in which a signal level changes so as to be approximately random numbers;
a multi-level processing step of combining the multi-level code sequence and the information data, and generating a multi-level signal having a plurality of levels corresponding to a combination of the multi-level code sequence and the information data; and
a modulation step of modulating the multi-level signal based on predetermined modulation processing and outputting a modulated signal, wherein
the modulation step includes:
a light modulation step of modulating, based on the multi-level signal, a lightwave outputted from a light source;
a branching step of branching the lightwave modulated based on the multi-level signal and outputting respective branched lights to a first light path and a second light path respectively having different light path lengths; and
an interfering step of causing lightwaves, which are outputted from the first light path and the second light path, to interfere with each other, and outputting an interfered lightwave as the modulated signal.

17. A data transmitting method for encrypting information data by using predetermined key information and performing secret communication with a receiving apparatus, the data transmitting method comprising:
a multi-level code generation step of generating, based on the predetermined key information, a multi-level code sequence in which a signal level changes so as to be approximately random numbers;
a multi-level processing step of combining the multi-level code sequence and the information data, and generating a multi-level signal having a plurality of levels corresponding to a combination of the multi-level code sequence and the information data; and
a modulation step of modulating the multi-level signal based on predetermined modulation processing and outputting a modulated signal, wherein
the modulation step includes:
a light transmitting step of transmitting a lightwave outputted from a light source; and
a light modulation step of modulating, based on the multi-level signal, the lightwave outputted from the light transmitting step,
the light transmitting step includes:
a first transmitting/reflecting step of causing the lightwave outputted from the light source to transmit at a predetermined transmission factor and to reflect at a predetermined reflection factor, respectively; and
a second transmitting/reflecting step of causing the lightwave, which is outputted from the first transmitting/reflecting step and then outputted after passing through a light path having a predetermined light path length, to transmit at a predetermined transmission factor and to reflect at a predetermined reflection factor.
